(19) United States
(12) Patent Application Publication
(10) Pub. No.: US 2008/0140786 A1
(43) Pub. Date: Jun. 12, 2008

(54) SYSTEMS AND METHODS FOR COMMERCIALIZING IDEAS OR INVENTIONS

(76) Inventor: Bao Tran, San Jose, CA (US)

Correspondence Address: TRAN & ASSOCIATES, 6768 MEADOW VISTA CT., SAN JOSE, CA, 95135, US

(21) Appl. No.: 11/744,715

(22) Filed: May 4, 2007

Related U.S. Application Data
(60) Provisional application No. 60/868,936, filed on Dec. 7, 2006.
(60) Provisional application No. 60/910,656, filed on Apr. 7, 2007.

(51) Int. Cl. G06F 15/16

(52) U.S. Cl. 709/206

(57) ABSTRACT

Systems and methods are disclosed to commercialize intellectual property (IP) by posting on an IP social network publicly accessible information relating to an IP asset; providing a messaging system linking members of the IP social network; and promoting the IP asset using the IP social network.

This application claims priority to Provisional Application Ser. Nos. 60/868,936 filed on Dec. 7, 2006 and 60/910,656 filed on Apr. 7, 2207, the contents of which are incorporated by reference.

### BACKGROUND

This invention relates to a system to protect and commercialize ideas.

Frequently people come up with new ideas that enhance a particular product or a way of doing business. However, as most companies do not accept unsolicited ideas under confidentiality, the inventors can hire a lawyer and file a patent application first before approaching these companies. However, as the cost of hiring patent lawyers can be quite expensive, and since many companies do not sign confidentiality agreements or non-disclosure agreements (NDAs) for unsolicited ideas, many inventors face the unpalatable choices of 1) submitting their ideas for free to a company that can benefit from the invention or 2) letting their ideas go unused, resulting in abandonment of the invention.

### SUMMARY

In a first aspect, systems and methods are disclosed to commercialize intellectual property (IP) by posting on an IP social network publicly accessible information relating to an IP asset; providing a messaging system linking members of the IP social network; and promoting the IP asset using the IP social network.

In a second aspect, system and methods commercialize intellectual property (IP) by posting on an IP social network publicly accessible information relating to an IP asset; selecting one or more contacts to create a private discussion group within the IP social network; providing a messaging system linking members of the IP social network; performing one of: vote on the IP asset, rate the IP asset, tag the IP asset using folksonomy, blog on the IP asset, disseminate information on the IP asset using Really Simple Syndication (RSS), comment on the IP asset, discuss prior art, send a description of the IP asset to another person; and providing an on-line marketplace for the IP asset.

Implementations of the above first and second aspects may include one or more of the following. The user can vote on the IP asset, rate the IP asset, tag the IP asset using folksonomy, blog on the IP asset, disseminate information on the IP asset using Really Simple Syndication (RSS), comment on the IP asset, discuss prior art, or send a description of the IP asset to another person. The user can also submit a listing to digg.com, netscape.com, del.icio.us, flickr.com, slashdot.com, or youtube.com, among others. A reward can be paid for prior art relevant to the IP. An on-line marketplace is provided to commercialize the IP asset. The system supports soliciting for help through the IP social network to crow-source one or more ideas or inventions addressing a predetermined problem. The system can value or appraise the IP asset based on one of: a similar prior transaction, a cash flow analysis, a reasonable royalty analysis. Escrow can be provided to facilitate IP asset transfer between two or more parties. The user can select one or more contacts to create a private discussion group. The system can determine a connection path from an existing contact to a predetermined person not a member of the private discussion group using social network analysis. The user can request an introduction from an existing contact to a predetermined desired person if that desired person is one connection away, or alternatively, if the person is n level away, the user can follow the connection path and ask for one or more additional introductions to invite a predetermined person to join the private discussion group. Alternatively, the user can pay the system for an introduction to invite a predetermined person to join the private discussion group. The messaging system can receive an offer from one or more members of the IP social network, including: a business partner, an engineering professional, a sales professional, a marketing professional, a manufacturing professional, a compliance professional, a business professional. The system also supports IP protection by generating a patent application describing the IP asset; providing a visual user interface including a tree-based visualization of parts of the patent application; providing a drag-and-drop user interface to facilitate generating language recited in each claim of the patent application; and providing diagnostics on the patent application. The patent application can be filed using an Electronic Filing System (EFS) or using an application programming interface (API) to communicate the patent application and supporting data with a patent office. The system displays ads from search engines such as ads from Google or ads directly placed with the system. The system can communicate a bid from one or more patent professionals reviewing the publicly accessible information to convert a provisional patent application to a utility patent application. The system can also provide an automated system to convert a provisional application into a utility patent application. A docketing system can be provided to calendar one or more deadlines and copying electronic files associated with the patent application from one or more patent offices and allowing a user to locally access the copied electronic files. An on-line auction such as the eBay auction engine can be used to sell the IP asset in an auction format.

In a third aspect, systems and methods are disclosed to commercialize intellectual property (IP) by generating a patent application describing the IP; filing the patent application; providing a publicly accessible description of the IP on a social network; and using the social network to promote the IP.

In a fourth aspect, systems and methods are disclosed to commercialize IP by: filing a provisional application to temporarily protect the IP; providing a publicly accessible description of the IP on a social network; using the social network to promote the IP; and converting the provisional application to a utility application within one year from provisional filing.

In a fifth aspect to sell the invention quickly to avoid the costs associated with converting the provisional to a utility application, systems and methods are disclosed to commercialize IP by: filing a provisional application to temporarily protect the IP; providing a publicly accessible description of the IP on a social network; and using the social network to sell the IP within one year from provisional filing.

In a sixth aspect where patent professionals can buy expiring provisional patent applications at bargain price, systems and methods are disclosed to commercialize IP by: filing a provisional application to temporarily protect the IP; providing a publicly accessible description of the IP on a social network; buying the IP after the tenth month from provisional filing at a discounted price; and converting the provisional application to a utility application within one year from provisional filing.

In a seventh aspect where the system is used to attract investors and partners, systems and methods are disclosed to commercialize IP by: filing a provisional application to temporarily protect the IP; providing a publicly accessible description of the IP on a social network; and using the social network to attract investors and partners in commercializing the IP; and converting the provisional application to a utility application within one year from provisional filing.

Implementations of the 3^{rd} through the 8^{th} aspects may include one or more of the following. The user can vote on the IP asset, rate the IP asset, tag the IP asset using folksonomy, blog on the IP asset, disseminate information on the IP asset using RSS, comment on the IP asset, discuss prior art, or send a description of the IP asset to another person. The user can also submit a listing to digg.com, netscape.com, del.icio.us, flickr.com, slashdot.com, or youtube.com, among others. A reward can be paid for prior art relevant to the IP. An on-line marketplace is provided to commercialize the IP asset. The system can value or appraise the IP asset based on one of: a similar prior transaction, a cash flow analysis, a reasonable royalty analysis. Escrow can be provided to facilitate IP asset transfer between two or more parties. The user can select one or more contacts to create a private discussion group. The system can determine a connection path from an existing contact to a predetermined person not a member of the private discussion group using social network analysis. The user can request an introduction from an existing contact to a predetermined desired person if that desired person is one connection away, or alternatively, if the person is n level away, the user can follow the connection path and ask for one or more additional introductions to invite a predetermined person to join the private discussion group. Alternatively, the user can pay the system for an introduction to invite a predetermined person to join the private discussion group. The messaging system can receive an offer from one or more members of the IP social network, including: a business partner, an engineering professional, a sales professional, a marketing professional, a manufacturing professional, a compliance professional, a business professional. The system also supports IP protection by generating a patent application describing the IP asset; providing a visual user interface including a tree-based visualization of parts of the patent application; providing a drag-and-drop user interface to facilitate generating language recited in each claim of the patent application; and providing diagnostics on the patent application. The patent application can be filed using an Electronic Filing System (EFS) or using an application programming interface (API) to communicate the patent application and supporting data with a patent office. The system displays ads from search engines such as ads from Google or ads directly placed with the system. The system can communicate a bid from one or more patent professionals reviewing the publicly accessible information to convert a provisional patent application to a utility patent application. The system can also provide an automated system to convert a provisional application into a utility patent application. A docketing system can be provided to calendar one or more deadlines and copying electronic files associated with the patent application from one or more patent offices and allowing a user to locally access the copied electronic files. An on-line auction such as the eBay auction engine can be used to sell the IP asset in an auction format. Diagnostics can be provided on the patent application. AJAX techniques can be used to generate the patent application over the Web. A visual user interface can provide a tree-based visualization of parts of the patent application. A drag-and-drop user interface facilitates generating language recited in each claim of the patent application. The patent application can be in a portable document format such as a PDF document. The resulting patent application can be filed with EFS. The system can directly upload the patent application and supporting data to a patent office using an application programming interface (API). One or more tags can be generated by users to describe the IP (folksonomy). A multimedia file such as a video or pictures can describe the IP. The web site user can perform one of: vote on the IP, to rate the IP, to discuss or comment on the IP, to email a description of the IP to another person. The user to submit a link referencing the IP on one of: digg.com, netscape.com, flickr.com, slashdot.com. Prior art document can be uploaded or referenced using a URL link or alternatively comments can be made on prior art for the IP. A reward can be offered for prior art relevant to the IP. Information pertinent to the IP can be provided to a patent office for patentability determination. An on-line marketplace for the IP can be provided. Tools such as IP valuation or assessment can provide guidelines for sellers or buyers or interested parties. Escrow can facilitate a transfer of the IP. The patent application can be a provisional application or a utility application or any patent application designation that the patent office provides. Bids from one or more patent professionals reviewing the publicly accessible information can be used to select a professional who converts the provisional patent application to a utility patent application. For low price, an automated system can convert the provisional application into a utility patent application. A docketing system can be used to calendar one or more deadlines. The system can download electronic files associated with the patent application from one or more patent offices so that local copies can be viewed without the latency of Internet access. An internal messaging system links members of the social network. A user can create one or more discussion groups and wherein at least one discussion group provides information valued by the user. The user can receive an offer from one or more of: a business partner, an engineering professional, a business professional, an investor, to start a business venture. The offer can also be from one or more investors reviewing the publicly accessible information to fund a business venture.

Advantages of the system may include one or more of the following. Support groups with users who actively contribute to the commercialization can be formed using a built-in messaging system and with the social network analysis. The network can also be used to determine the social capital of individual users, actors or members of the social network. The social capital can be displayed in a social network diagram, where nodes are the points and ties are the lines. The IP social structure is made of nodes (which generally represent individuals or organizations) that are tied by one or more specific types of relations, such as technology relationship, IP trading relationship between sellers/buyers, IP investing relationship among investor or partner, and IP connections. In one embodiment, an IP social network is a map of all of the relevant ties between the nodes being studied. Social network analysis views social relationships in terms of nodes and ties. Nodes are the individual actors within the networks, and ties are the relationships between the actors. There can be many kinds of ties between the nodes. The shape of a social network helps determine a network's usefulness to its individuals. Smaller, tighter networks can be less useful to their members than networks with lots of loose connections (weak ties) to individuals outside the main network. More open networks, with many weak ties and social connections, are more likely to introduce new ideas and opportunities to their members than closed networks with many redundant ties. In other words, a group of friends who only do things with each other already share the same knowledge and opportunities. A group of individuals with connections to other social worlds is likely to have access to a wider range of information. It is better for individual success to have connections to a variety of networks rather than many connections within a single network. Similarly, individuals can exercise influence or act as brokers within their social networks by bridging two networks that are not directly linked (called filling structural holes). Members of the support group can include angel investors, influential users who can serve as board advisors, engineers who can contribute to the implementation and productizing of the idea, and professionals such as lawyers and accountants who help build a corporate structure behind the idea. Other members can include idea buyers. Buyers have access to an idea marketplace that they can purchase fresh ideas using crowdsourcing at a lower cost than internally developing these ideas since the buyers are tapping into the collective intelligence of the crowd. Thus, the system provides a marketplace for ideas that benefit the inventors, the buyers, as well as the support infrastructure needed to bring an idea to the market.

Other advantages may include one or more of the following. The system allows the user to inexpensively protect their ideas by providing tools to prepare provisional patent applications. The system provides guidance and diagnostics to help people who are unfamiliar with the requirements imposed on patent applications by the patent office. The system also provides a support network of patent professionals to help the user convert the provisional to a utility application and to prosecute the patent application. Once protected, the system helps the user to market his/her ideas through an idea marketplace. The marketplace can reward top ideas by placing these top ideas in the home page of the site as well as in the home page of each major topic/channel. Viewers can vote on the idea and can contact the inventor to offer services and support such as legal, engineering, and financing, among others.

Yet other advantages may include the following. The system harnesses collective intelligence and leverages the long tail through customer self-service. Users add their own data to that which the system provides. The system offers web services interfaces and content syndication, and re-uses the data services of others such as the data services from the patent office web sites, del.icio.us, Flickr, Youtube, and Google, among others.

As users add new content, and new sites, it is bound in to the structure of the system over the web by other users discovering the content and linking to it, and the web of connections grows organically as an output of the collective activity of all web users. The system enables ease of use in providing user reviews of IPs, invitations to participate in varied ways on virtually every technology/topic—and even more importantly, the system applies user activity to produce better IP search results. Folksonomy is used to provide a style of collaborative categorization of IP content using freely chosen keywords, often referred to as tags. In the canonical example, an invention of an MP3 player such as the iPOD might be tagged both “music player” and “cute”—allowing for retrieval along natural axes generated user activity. The system allows the adoption of ideas and inventions to be driven by “viral marketing”—that is, recommendations propagating directly from one user to another.

The system supports blogs and RSS which allows someone to link not just to a page, but to subscribe to particular IP topcis, with notification every time that page changes. The system also supports permalink to easily gesture directly at a highly specific post on someone else's site and talk about it. The “blogosphere” allows inventors and innovative businesses to subscribe to each others' sites, and easily link to individual comments on a page, but also, via a mechanism known as trackbacks, they can see when anyone else links to their pages, and can respond, either with reciprocal links, or by adding comments.

The system also allows users to set watch lists—any user can subscribe to any other user's invention stream via RSS. The object of attention is notified, but does not have to approve the connection.

In yet another aspect, the system provides data that can be used by other Semantic Web (Web 3.0) sites as well as consume data from the system's own database or from other Semantic Web sites in flushing out details of an invention.

In the IP Semantic Web system, IP related data on the web is defined and linked in a way that it can be used by machines not just for display purposes, but for automation, integration and reuse of data across various applications.

The system can browse the Web and find what IP users are looking for based on what the system knows about the user's needs and the descriptive metadata they find on relevant sites. Data is connected to URLs containing descriptive information about that data. Information is neither static nor absolute; instead data is “an abstract concept” that gets definitions from another site explaining how to define the data.

To illustrate, in one example, the inventor invents a flying car by specifying a vehicle with at least two wheels, a frame coupled to the wheels, and an engine coupled to the frame to propel the vehicle through the air and the ground. Once the inventor has specified the claim(s), the system looks up prior art relating to vehicle frames, wheels, and engines and known equivalents thereof and automatically checks the prior art to see if it fits with the scope of the invention as defined by the inventor and to see if conflicts exist.

The Semantic Web system captures the true essence of meaning of each processed data object. The information allows the system to efficiently find the precise answer to queries, generate dynamic taxonomies of results, create on-the-fly summaries of located documents, and understand deep concepts such as cause-effect relationships. The system automatically provides simultaneous cross-language semantic search across multiple languages such as English, French, German and Japanese, among others. The objects being located are automatically transformed into their equivalent semantic concepts for the target languages allowing a single search to be processed against a variety of heterogeneous language knowledge bases.

In one example where the system automatically locates suitable propulsion device for the vehicle, the system treats “engine” as an abstract concept with definition from another invention or prior art explaining how to better define what engines can be used to make a flying vehicle. The system searches for non-patent documents that are tagged as relating to engines as well as patents that reference engine in the claims. Suitable candidates are brought back for the inventor to review. Upon inventor approval, the system automatically retrieves description associated with the object and customizes the object to fit with its environment as specified by the inventor.

Advantages of the Semantic Web aspect may include one or more of the following. The system allows data to be shared and processed by automated tools as well as by people. Inventors and IP users can quickly research hundreds to thousands of documents, find relevant concepts, and then quickly assess the overall relevance of the document to the problem at hand. The system automates Knowledge Capture and Sharing of Lessons Learned. The system automatically organizes tribal knowledge (including lessons learned) and external expertise into semantically-indexed knowledge bases, reading predetermined document types as well as unstructured data. The system delivers a platform to assist in idea generation, capture design intent, and optimize anticipatory problem analyses. The system enables product engineers, scientists and researchers to leverage and reuse technical content to minimize re-invention and to identify higher quality concepts—out of the gate—thereby minimizing costly rework. The system delivers an integrated and automated concept workbench for idea stimulation and concept generation—enabling engineers to conceive more and better ideas. Innovators can leverage knowledge to bring better-performing, more competitive, and more cost-effective products to market, faster.

The system, with its Web 2.0 and 3.0 features, enables a world in which “the former audience”, not a few people in a back room, decides what ideas or inventions are important and a world where computers can do the hard work that people used to do to arrive at new inventions.

### BRIEF DESCRIPTION OF THE DRAWINGS

FIG. 1A shows an exemplary process to generate and commercialize intellectual property.

FIG. 1B shows an exemplary process to generate and commercialize intellectual property.

FIG. 2 shows an exemplary inventive process.

FIG. 3A shows a first exemplary process to request solutions for a problem.

FIG. 3B shows a second exemplary process to request solutions for a problem.

FIG. 3C shows an exemplary Request a Solution form.

FIG. 4 shows an exemplary patent generation process.

FIG. 5 shows an exemplary process to file a patent application and to work on the prosecution of the application FIG. 6 shows an exemplary process to publicize or market the invention.

FIG. 7 shows an exemplary process where viewers can vote or comment on the invention.

FIG. 8 shows an exemplary messaging system.

FIG. 9 shows an exemplary process supporting a buyer portal.

FIG. 10 shows an exemplary process for buying and selling an invention.

FIG. 11 shows an exemplary process for trading or commercializing an invention.

FIG. 12 shows various exemplary user interfaces.

FIG. 13 shows an exemplary agent that operates with the Semantic Web (Web 3.0).

FIG. 14A shows a clustered server to provide high performance Ruby On Rails service.

FIG. 14B shows a grid computing system to provide high performance Ruby On Rails service.

### DESCRIPTION

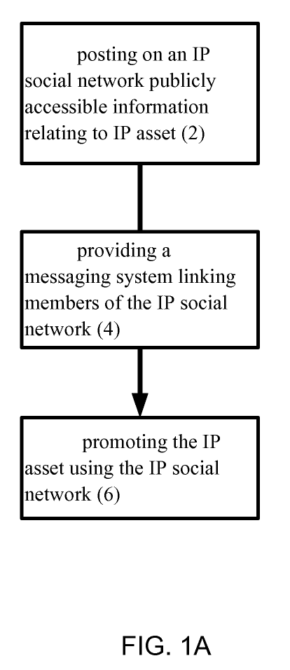

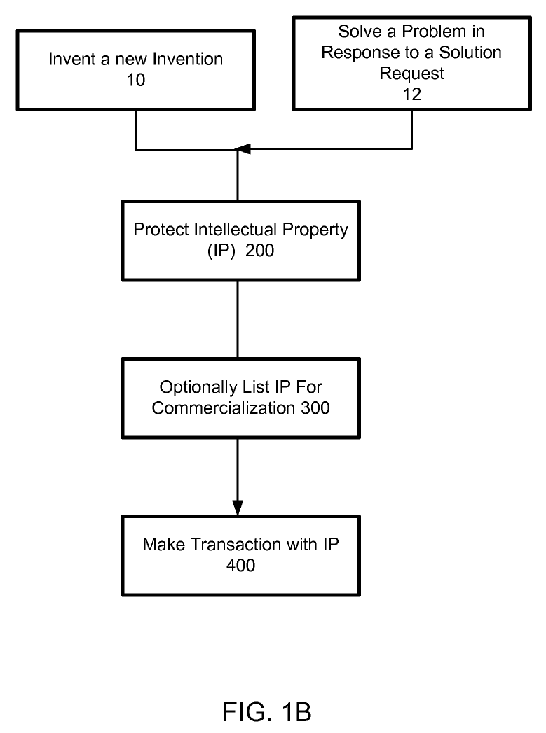

Referring to FIG. 1A, an exemplary process to generate and commercialize intellectual property is shown. In a first aspect, systems and methods are disclosed to commercialize intellectual property (IP) by posting on an IP social network publicly accessible information relating to an IP asset (2); providing a messaging system linking members of the IP social network (4); and promoting the IP asset using the IP social network (6).

The IP social network is exemplified by a series of relationship between members (nodes) who share a particular interest in a particular technology or field of invention. In the IP community, an initial set of founder inventors sends out messages inviting members of their own personal networks to join the site to comment on new ideas or inventions. The new ideas or inventions are tagged for the technology or field of invention and comments can be made on these ideas. The system can find members of the social network who share the same passion about a particular technology and allow the users to find each other and allow the inventor to tap into the wisdom of the crowd for instructive comments on his invention and for networking to find people who can help the inventor commercialize his/her invention or to find people to buy his ideas.

New members repeat the process, growing the total number of members and links in the network. The system offers features such as automatic address book updates, viewable profiles, the ability to form new links through “introduction services,” and other forms of online social connections. In one embodiment, the IP social network is public, allowing anyone to join. Organizations, such as large companies, also have access to private IP social networking applications, known as Enterprise IP Relationship Management. In one embodiment, organizations install the IP commercialization applications on their own servers and enable employees to share knowledge, ideas and inventions through their networks of contacts and relationships to outside people and companies.

In one embodiment, the system supports blended networking that combines both offline elements (face-to-face events) and online elements. This is achieved by linking members through conferences, trade shows, and face to face meeting using Google Maps mash-ups. In another embodiment, the IP social network analyzes links between inventor's web pages. Inventors and IP buyers or IP interested individuals begin with their address book, and expand their network by adding friends, “friendster” acquaintances and imaginary friends. This creates connectivity through being discovered through friends of friends, etc. The social networks of other inventors or IP interested parties can be discovered by stumbling upon them in another embodiment. In IP stumbling, users provide ratings to form collaborative opinions on website quality. When the user stumbles into a site, he/she will only see pages which friends and like-minded inventor stumblers have recommended. This helps the user discover great IP content that search engines will not find.

The messaging system provides a secure communication system where buyers, sellers, IP professionals, inventors and people interested in IP can communicate with each other. In one embodiment, the messaging system is private and archived by the system so that offers, comments, and all communications between parties are saved. Typically, upon receipt of incoming messages, the system

In a second aspect, system and methods commercialize intellectual property (IP) by posting on an IP social network publicly accessible information relating to an IP asset; selecting one or more contacts to create a private discussion group within the IP social network; providing a messaging system linking members of the IP social network; performing one of: vote on the IP asset, rate the IP asset, tag the IP asset using folksonomy, blog on the IP asset, disseminate information on the IP asset using Really Simple Syndication (RSS), comment on the IP asset, discuss prior art, send a description of the IP asset to another person; and providing an on-line marketplace for the IP asset.

The user can vote on the IP asset, rate the IP asset, tag the IP asset using folksonomy, blog on the IP asset, disseminate information on the IP asset using Really Simple Syndication (RSS), comment on the IP asset, discuss prior art, or send a description of the IP asset to another person. The user can also submit a listing to digg.com, netscape.com, del.icio.us, flickr.com, slashdot.com, or youtube.com, among others. A reward can be paid for prior art relevant to the IP. An on-line marketplace is provided to commercialize the IP asset. An IP buyer can solicit help for its unsolved needs through the IP social network by crow-sourcing one or more ideas or inventions addressing its unsolved needs or problems. The system can value or appraise the IP asset based on one of: a similar prior transaction, a cash flow analysis, a reasonable royalty analysis. Escrow can be provided to facilitate IP asset transfer between two or more parties. The user can select one or more contacts to create a private discussion group. The system can determine a connection path from an existing contact to a predetermined person not a member of the private discussion group using social network analysis. The user can request an introduction from an existing contact to a predetermined desired person if that desired person is one connection away, or alternatively, if the person is n level away, the user can follow the connection path and ask for one or more additional introductions to invite a predetermined person to join the private discussion group. Alternatively, the user can pay the system for an introduction to invite a predetermined person to join the private discussion group. The messaging system can receive an offer from one or more members of the IP social network, including: a business partner, an engineering professional, a sales professional, a marketing professional, a manufacturing professional, a compliance professional, a business professional.

The system also supports IP protection by generating a patent application describing the IP asset; providing a visual user interface including a tree-based visualization of parts of the patent application; providing a drag-and-drop user interface to facilitate generating language recited in each claim of the patent application; and providing diagnostics on the patent application. The patent application can be filed using an Electronic Filing System (EFS) or using an application programming interface (API) to communicate the patent application and supporting data with a patent office. The system displays ads from search engines such as ads from Google or ads directly placed with the system. The system can communicate a bid from one or more patent professionals reviewing the publicly accessible information to convert a provisional patent application to a utility patent application. The system can also provide an automated system to convert a provisional application into a utility patent application. A docketing system can be provided to calendar one or more deadlines and copying electronic files associated with the patent application from one or more patent offices and allowing a user to locally access the copied electronic files. Additional details on automatic IP generation and docketing are disclosed in commonly owned, co-pending patent applications having Ser. Nos. 09/792,828; 11/405,323; 09/842,599; 10/764,647; 10/779,537; 10/804,739; 10/938,784; 10/804,729, the contents of which are incorporated by reference.

An on-line auction using an auction engine can be used to sell the IP asset in an auction format. Buyers typically enter the auction engine through an IP Market page, which contains a listing of inventive categories that allows for easy exploration of current auctions. Bidders can search for specific IP assets by browsing through a list of auctions within a category or subcategory and then “click through” to a detailed description for a particular IP asset. Bidders can also search specific categories or the entire database of auction listings using keywords to describe the types of IPs in which they are interested, and the system search engine will generate a list of relevant auctions with links to the detailed descriptions. Each auction is assigned a unique identifier so that users can easily search for and track specific auctions. Users can also search for a particular bidder or seller by name in order to review his or her auction and feedback history. Within each category section the system highlights auctions commenced within the past 24 hours in a “New Today” section; auctions ending on that day in an “Ending Today” section; and auctions ending within three hours under a “Going, Going, Gone” section. Once a bidder has found an item of interest and registered with the system, the bidder enters the maximum amount he or she is willing to pay at that time. In the event of competitive bids, the service automatically increases bidding in increments based upon the then current highest bid for the item, up to the bidder's maximum price. As the system encourages direct interaction between buyers and sellers, bidders wishing additional information about a listed IP asset can contact the seller using the messaging system for additional information. The interaction between bidders and sellers leverages the personal, one-to-one nature of person-to-person trading on the Web and is an important element of the IP auction experience. Once each bid is made, a confirmation is sent to the bidder via email, an outbid notice is sent to the next highest bidders and the item's auction status is automatically updated. During the course of the auction, bidders are notified of the status of their bids via email on a daily basis and are notified immediately after they are outbid. Bidders are not charged for making bids or purchases through the system. A seller registered with the system can list a product for auction by completing a short online form. The seller selects a minimum price for opening bids for the item and chooses whether the auction will last three, five or seven days. Additionally, a seller may select a reserve price for an item, which is the minimum price at which the seller is willing to sell the item and is typically higher than the minimum price set for opening bids. The reserve price is not disclosed to bidders. A seller can elect to sell items in individual auctions or, if he or she has multiple identical items, can elect to hold a “Dutch Auction.” For example, an individual wishing to sell 10 IP assets could hold 10 individual auctions or hold a Dutch Auction in which the 10 highest bidders would each receive an IP asset and all lower bids would be rejected. A seller may also specify that an auction will be a private auction. With this format, bidders' contact addresses are not disclosed on the item screen or bidding history screen. By paying incremental placement fees, sellers can have items featured in various ways. The seller can highlight his or her auctions by utilizing a bold font for the auction heading for an additional fee. A seller with a favorable feedback rating can have his or her auction featured as a “Super Featured Auction” which allows the seller's item to be rotated on the system's home page, or as a “Category Featured Auction” which allows the seller's item to be featured within a particular invention field or category. A seller can also include a description of the IP with links to the seller's Web site. In addition, the seller can include a video in the description if the seller posts the video on a Web site and provides the system with the appropriate Web address.

During the course of an auction, sellers are notified of the status of their auctions on a daily basis via email. At the end of an auction period, if a bid exceeds the minimum price and, if one is set, the reserve price, the system automatically notifies the buyer and seller via email and the buyer and seller can then consummate the transaction independently of the system. The buyer and seller must independently arrange for the shipment of and payment for the item, with the buyer typically paying for shipping. A seller can view the buyer's feedback rating and then determine the manner of payment, such as personal check, cashier's check or credit card, and also whether to ship the item before or after the payment is received.

A feedback forum facilitates the establishment of reputations within its community by encouraging individuals to record comments about their trading partners on each transaction or other HugeIdea users with whom they have interacted. Every registered user is issued a trading profile, on which users who have conducted business or interacted with the person may submit compliments or criticism. This information is recorded in a feedback profile that includes a feedback rating for the person and indicates comments from other users who have interacted with that person over the past seven days, the past month, the past six months and beyond. Users who have developed positive reputations over time will have a star symbol displayed next to their user name, which is color coded to indicate the amount of positive feedback as compared to negative feedback received by the user. The users may review a person's feedback profile to check on the person's reputation within the community before deciding to bid on an item listed by that person or in determining how to complete the payment for and delivery of the item. The Feedback Forum system has several automated features designed to detect and prevent some forms of abuse. For example, feedback posting from the same account, positive or negative, cannot affect a user's net feedback rating (i.e., the number of positive postings, less the number of negative postings) by more than one point, no matter how many comments an individual makes. Furthermore, in order to discourage users from registering for the purpose of leaving excessive positive or negative feedback, a user must be registered with the system for at least five days in order to leave feedback. Users who receive a sufficiently negative net feedback rating have their registrations suspended and are unable to bid on or list items for sale. The Company believes its Feedback Forum is extremely useful in overcoming initial user hesitancy when trading over the Web as it reduces the anonymity and uncertainty of dealing with an unknown trading partner.

The above Internet-based centralized trading place overcomes the inefficiencies associated with traditional person-to-person trading by facilitating buyers and sellers meeting, listing items for sale, exchanging information, interacting with each other and, ultimately, consummating transactions. Through such a trading place, buyers can access a significantly broader selection of IP assets to purchase and sellers have the opportunity to sell their IP assets efficiently to a broader base of buyers. As a result, a significant market opportunity exists for an Internet-based centralized trading place that applies the unique attributes of the Internet to facilitate person-to-person trading for IP assets.

Turning now to FIG. 1B, another exemplary IP commercialization process is shown. An inventor through his or her personal experience can invent a new invention to solve a problem that the inventor has personal experience with (10). Alternatively, the inventor can solve a problem in response to a solution request from a third party requester or sponsor who are willing to pay for a solution (12).

In FIG. 1, once the solution is reached, the inventor protects the intellectual property (IP) using IP law (200). In one embodiment, the patent system is used to protect the invention. After protecting his or her right in the IP through a patent filing, the inventor can commercialize the invention himself by forming a business to commercialize the invention. Alternatively, if the inventor wishes to sell the invention or wishes to get help in moving the invention from a paper design into production, the inventor can list the IP for third parties to bid on or to render assistance in exchange for a stake in the invention (400).

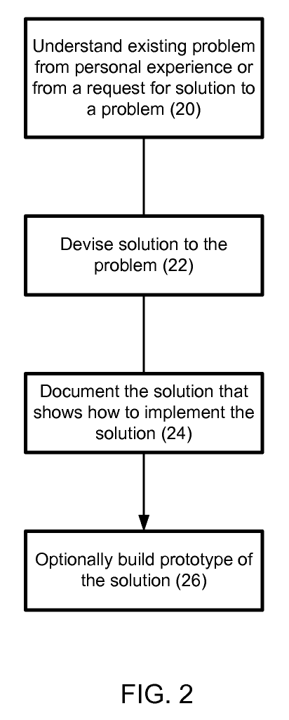

Turning now to FIG. 2, a process for arriving at a new invention is shown. In FIG. 2, a person identifies an existing problem to be solved or alternatively, selects a problem that has been posted by another entity (20). The inventor devises one or more solutions to the problem (22) and documents the solution in depth (24). The inventor can, but does not need to, implement a prototype of the invention (26).

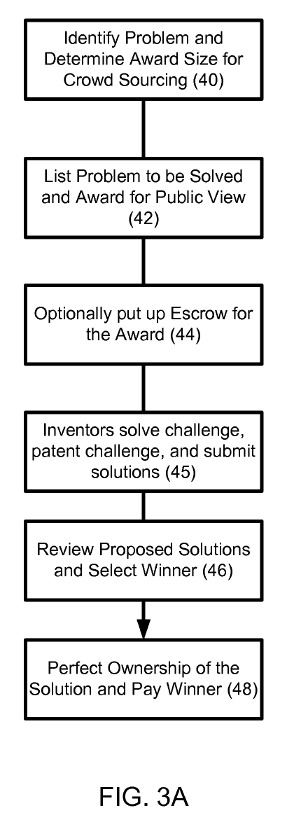

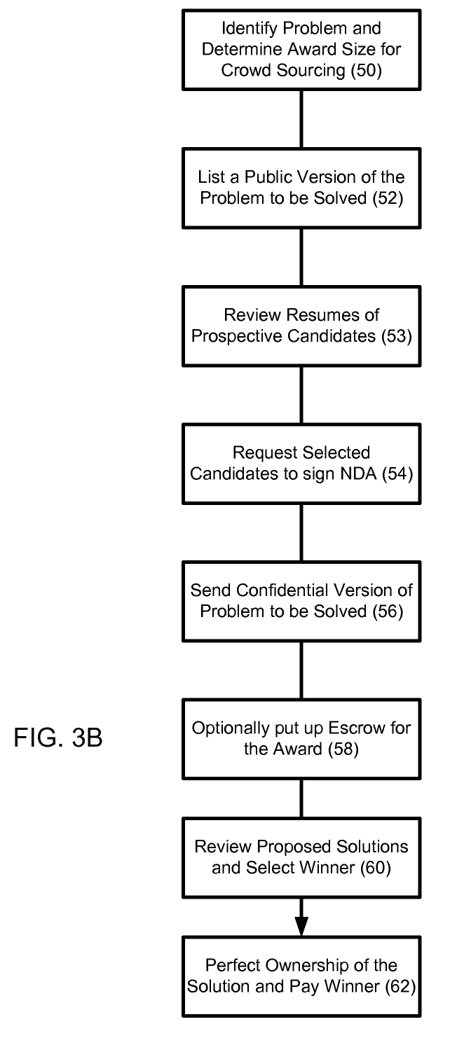

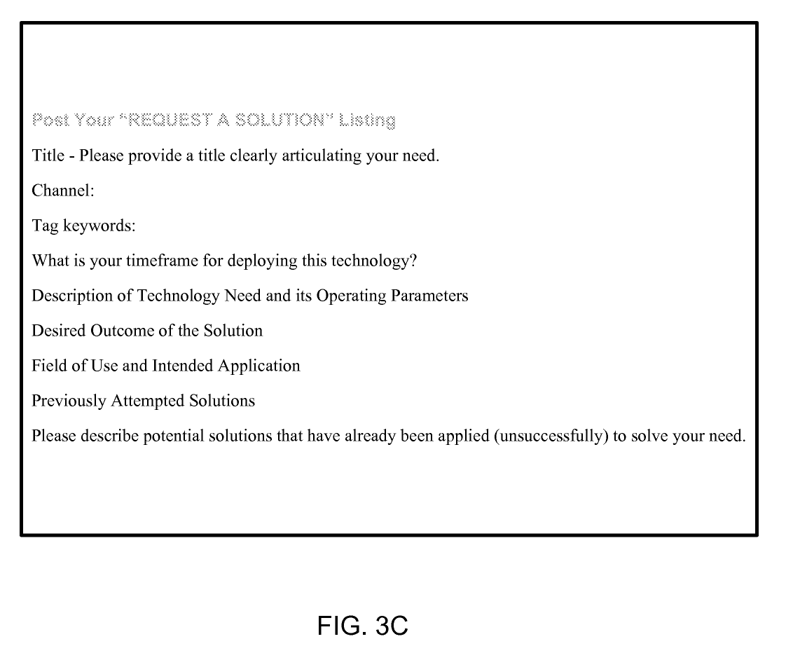

FIGS. 3A and 3B show two exemplary processes for crowd-sourcing new ideas. Crowdsourcing represents the act of a company or institution taking a function once performed by employees and outsourcing it to an undefined (and generally large) network of people in the form of an open call. A million heads are better than one. The crowd sourcing process takes advantage of the networked world and taps into the productive potential of millions of plugged-in enthusiasts. Using the system, hobbyists, part-timers, and dabblers suddenly have a market for their efforts, as smart companies in industries as disparate as pharmaceuticals and television discover ways to tap the latent talent of the crowd. The cost is defined up front and the process can costs a lot less than paying traditional employees.

FIG. 3A shows a first embodiment for crowdsourcing. In FIG. 3A, the third party (such as a company) identifies a problem to be solved and the amount of the award to the winning inventor (40). The crowdsourcer lists the problem to be solved and the award or prize on a web site (42). If the crowdsourcer has a brand name reputation, the challenge may be posted without any other security on the prize. Alternatively, the crowdsourcer may wish to remain anonymous, or if the crowdsourcer is not well known, the crowdsourcer may put up all or a portion of the prize or award into escrow to ensure participants that the prize is funded (44). Participants work on the challenge, file patent applications covering their IP, and submit proposals to the crowdsourcer (45). The crowdsourcer evaluates the proposals and selects a winner (46). Before paying the winner, the crowdsourcer perfects its ownership of the IP through assignments and releases from the employer of the inventor if that is an issue (48).

FIG. 3B shows a second embodiment of crowd sourcing where the crowdsourcer is concerned about confidentiality. In this embodiment, the crowdsourcer identifies the problem and sets the prize (50). A public version of the challenge is posted (52), and prospective candidates submit their resume for evaluation for review (53). The crowdsourcer selects qualified candidates and requests that they sign confidentiality agreements before allowing the participants to receive a non-public description of the challenge to be solved (54). Next, the confidential version of the challenge is transmitted to the group that signed the confidentiality agreements (56). The crowdsourcer can put up a deposit or an escrow for the award (58). The crowd works on the problem and files patent protection before submitting proposals to the crowdsourcer. The crowdsourcer reviews the proposed solutions and selects a winner (60). Next, the ownership of the solution is perfected by the crowdsourcer and the winner is paid the prize (62). FIG. 3C shows an exemplary input form that the crowdsourcer enters into the system to submit a request for solution. In one embodiment, the form requests for information such as Title, Channel (or topic), Tag keywords, the Timeframe for deploying this technology, the Description of Technology Need and its Operating Parameters, the Desired Outcome of the Solution, the Field of Use and Intended Application, Previously Attempted Solutions, and any potential solutions that have already been applied (unsuccessfully) to solve the problem.

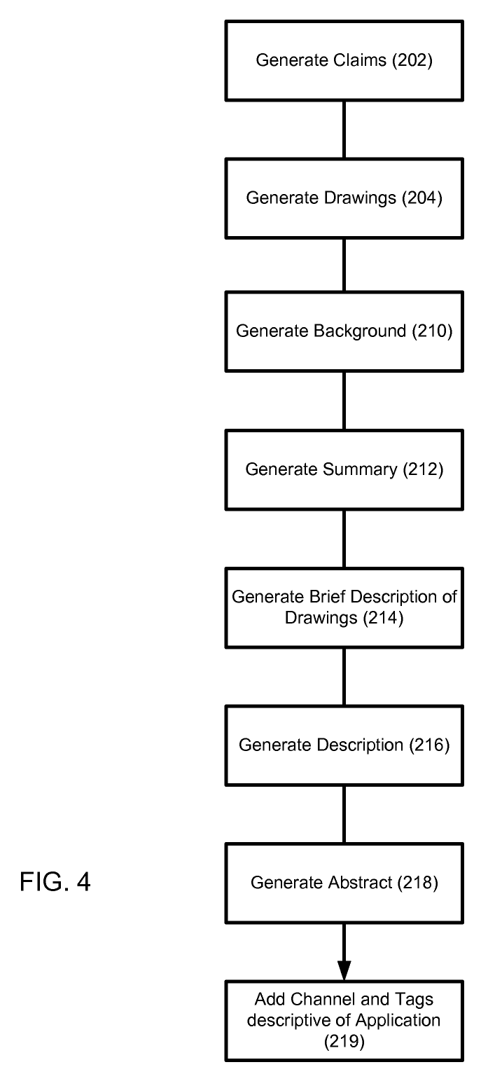

Turning now to FIG. 4, an exemplary process to generate a patent application is shown. First, the system generates claims for the application (202). Alternatively, for provisional application, the user can enter a high level summary of the invention as the main claim and then enter variations (bells and whistles) as the dependent claims. The claims can be visually generated using drag-and-drop user interface as well as a tree organization structure. In such a visual claim generation methodology, elements of the claims are sketched as a graph with elements of the claim occupying different branches on the tree. Each element can be selected and added. The elements can be dragged to associate with a different branch. Claim dependency can be visually edited by dragging and dropping the claims to depend on different parent. Drawings showing the claims are then generated (204). A background is entered (210). The background can be a one line description about the art, or alternatively can be a description of the prior art. Next, a summary is generated (212) and a brief description of the drawings is generated (214). A detailed description is entered (216), and an abstract is generated (218). More details on the generation of sections of the patent application including the visual claim generation as well as diagnostics that can be generated based on the user text entry are described in commonly owned, co-pending patent applications having Ser. Nos. 09/792,828; 11/405,323; 09/842,599; 10/764,647; 10/779,537; 10/804,739; 10/938,784; 10/804,729, the contents of which are incorporated by reference. In addition, the system prompts the user to select a channel (or a topic) description as well as one or more tags to facilitate searching and classification of the invention (219). Tags are descriptive words the inventor or submitter should add to his or her submissions to make them easier for others to find. For example, an invention about a new iPod might have the followings tags: Apple, iPod, mp3, Steve Jobs. The inventions listed on tag pages are ranked in the same way as they are on the channel pages. A tag cloud (or weighted list in visual design) can be used as a visual depiction of content tags for inventions entered on the site. In one embodiment, more frequently used tags are depicted in a larger font or otherwise emphasized, while the displayed order is generally alphabetical. Thus, finding a tag by alphabet and by popularity is possible. Selecting a single tag within a tag cloud will generally lead to a collection of items that are associated with that tag.

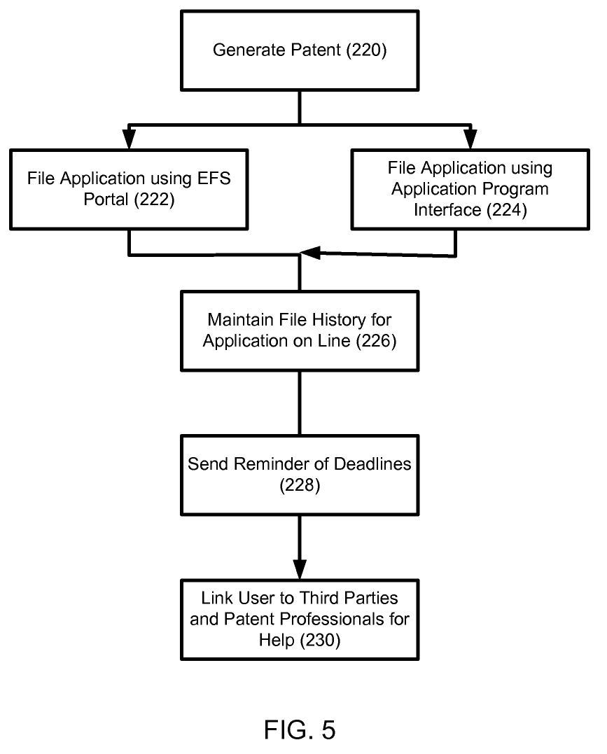

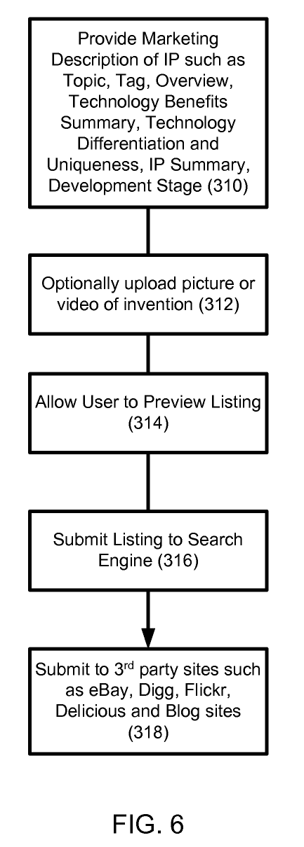

FIG. 5 shows an exemplary process for the patent filing and post-patent filing work. First, the patent application is generated (220). The patent application can be done using a word processor, typewriter or using the system of FIG. 4, among others. The document can then be sent to the Patent Office by mail, or can be filed by the user through the US PTO's registered or unregistered EFS portal (222) or can be filed directly by computer software through an application program interface (API) without going through EFS (224).

In one embodiment, the API uses XML (Extensible Markup Language), the language that specifies the structure and content of an XML document, to implement all forms and schedules in electronic format for e-Filing. The filing data is structured into a series of schemas. A schema is an XML document that specifies the data elements, structure, and rules for each form, schedule, document, and/or attachment. There are business rules in addition to rules defined by schema. Within the XML schema, data elements are the basic building blocks of an XML document. The schema recognizes two categories of element types: complex and simple. A complex type element is an element that has one or more attributes or is the parent to one or more child elements. A simple type element contains only one data type and may only have documentation attributes. Each field on a form, document, or attachment is identified using an XML tag name within the XML schema. Attributes provide additional information or describe a feature of a data element. Repeating data elements or groups of data elements provide a consistent structure to capture information that is requested. The API supports the attachment of one or more PDF files that are included in an attachment folder in a submission zip file. The API provides fields for the type of application (design, utility, provisional, US National Stage, or International Application for filing in US receiving office), the last name, first name and email address of the filer; the title of the invention, the attorney docket number, the first, middle and last name of the inventor, a customer number or a correspondence address, and one or more files, each file with a category and a document description. Each file may also be a multi-document and the API allows each document within a file to be defined by a start page number and an end page number. The API also provides for errors to be communicated back to the software so that the user can be informed of the error. Many errors relate to the font embedded in the PDF document, so the system defaults to “print as image” as a PDF file to avoid the embedded font issue.

The software communicating through the API can log in as a registered user so that the advantages of being a registered user are afforded to the user. A Registered e-filer has both an assigned Customer Number and Digital Certificate for secure access to application documents both during and after the filing of a patent application. The Digital Certificates provide an e-Filer with the ability to authenticate sessions by requiring positive identification of a customer using Public Key Infrastructure technologies. The Holders of Digital Certificates can take advantage of streamlined logins. The Registered e-Filers who authenticate can save “in-progress” submissions and return to edit them prior to completing filing. This ability to save “in-progress” submissions provides added protection against loss of data in the event of a localized internet or office equipment failure or in the event of an unplanned system outage during an online filing session. The Registered e-Filers can electronically process subsequent actions on electronically filed cases without delay. Registered e-Filers can review their confidential private PAIR records for most of their electronically filed cases.

Once filed, the user can use the PTO's public or private PAIR system to maintain the file history. Alternatively, through the API, the system can download the file history for docketing purposes (226). Based on predetermined deadlines (such as the one year foreign filing deadline or the 3 month office action response deadline, among others), the system can send user a reminder of the deadline (228). The system also links user to patent professionals and third parties such as foreign agents to provide help in prosecution of the application (230).

Turning now to FIG. 6, a process to market the invention is shown. This process is optional if the inventor wishes to sell, trade, or get other people involved in the commercialization of the invention. Inventors who intend on commercializing the inventions themselves in a start-up business would not need to use the process of FIG. 6 to trade or sell the invention. First, the user is prompted to provide non-confidential marketing description of IP such as the Channel or Topic, Tag, Overview, Technology Benefits Summary, Technology Differentiation and Uniqueness, IP Summary, Development Stage (310). Optionally the user can upload a picture or video of the invention (312). The system allows the user to preview the listing (314) before submitting the listing to the search engine (316) so that third parties can view the listing. Additionally, the user can submit to other sites such as ebay.com, digg.com, flickr.com, delicio.us, and other blog sites (318). With an auction portal such as eBay, the inventor can put the invention for bidding with an expiration deadline and a minimum price floor. Alternatively, the inventor can simply negotiate with the buyers without imposing the pressure of a bidding process on the buyers.

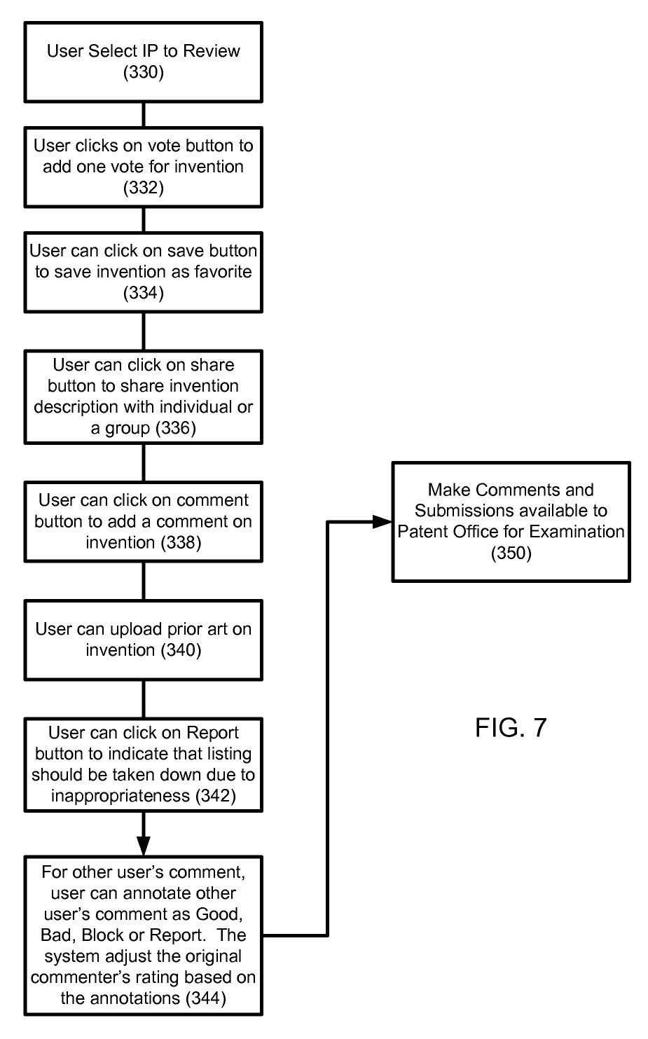

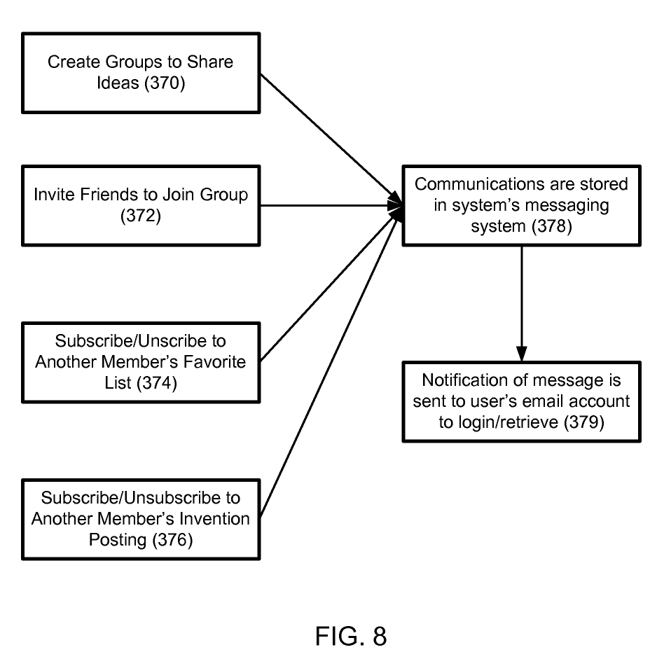

FIG. 7 shows an exemplary user comment process. First, the user views a summary listing page with a plurality of inventions shown therein. The listing may be a Home Page. The inventions shown on the Home Page are a cross-section of the most popular inventions on the system as determined by votes and comments from its members. The Home Page consists of a predetermined list of inventions such as 25 inventions. In one implementation, the 25 inventions consist of 2 inventions from each of the top 10 most popular channels and 1 invention from each of the next 5 most popular channels. These inventions are all individually ranked via an algorithm based on the number of votes and comments that a post has received. The channels themselves are ranked based on the number of high-ranking inventions and traffic they receive. As a result, the Home Page experience is a diverse news experience on inventive ideas that changes often throughout the day, based on the interests of its readers. Inventions submitted to each of the channels are purely ranked based on an algorithm that gives each of the member-submitted inventions a score based on the number of votes on the post, the number of comments on the post, and the age of the post. The user doesn't have to become a member to read the inventions on the site, however if the user would like to vote for, comment on, or submit inventions the user needs to register. Another major benefit of registration is that the user can “add friends” and watch what inventions they vote for, comment on, and submit-like a shared reading list.

Referring now to FIG. 7, one embodiment of the user comment process is shown. First, the user selects the invention to review (330). Next, the user click on a vote button to add one vote to the invention (332). This vote is used by the system to determine whether the listing is then displayed on the Home Page as discussed above. The user can also save the invention in his/her favorite list (334). Friends of the user who subscribe to the user's favorite list will also receive information on this invention. The user can also immediate share the information on the invention with one or more friends (336). The user can comment on the idea (338), and if the user knows of prior art on the invention, the user can upload the document that describes the prior art (340). To handle spam or inappropriate listings, the user can report the listing so that the site can examine and take down the posting if it is spam. If sites are reported by users or the anti-spamming algorithms for spamming the system with listings, the system places a temporary ban on the site while we investigate and as a warning to the possible spammers. Spam includes unwanted content that is often trying to sell the user something. For example, if a group of individuals (or a single individual registering multiple The system member accounts) only post links to inventions with which they are affiliated and only vote and comment on inventions with which they are affiliated and all these actions are clearly a coordinated effort to push the inventions to the Home Page, these individuals are manipulating the system and spamming the system with their submissions. Further, the same concept is applied to other user's comments so that the community can police itself and remove spammers from commenting. Thus, for other user's comments, the user can annotate as Good, Bad, Block or Report (344). Each annotation is used to rank the trustworthiness of a particular user. Users with high number of Good annotations are viewed as more trustworthy and their comments are more valuable.

Comments on the inventions can be made available to the patent office(s) during examination of the patent application (350). The comments can include comments on prior art as well as obviousness. The community can identify the central elements of the claims by voting. To provide sufficient quality, community peer review and deletion techniques ensure that entries posted are appropriate and adhere to standards of quality. Thus, entries without references or sources are rejected. The output at the end of the process is a rank ordered list of prior art, identifying the top ten submissions as judged by the community. Finally, participation is enhanced through status and reward. In one embodiment, users can receive point for being “submitter of the month” or “ranker of the month.”

Turning to FIG. 8, an exemplary messaging system is shown. The user can create different groups to share ideas (370). For example, one group may be engineering advisor group, and another group may be professional service group such as lawyer/accountant, and another group may be financing group such as investors. The user can invite friends to join one or more email distribution groups set up by the user (372). The user can subscribe to another member's profile and in one embodiment would have access to that member's favorite list (374). The user can also unsubscribe to the other member's postings (376). The internal messages are stored in an email system such as sendmail (378) and notification of pending messages are then communicated with the user to prompt the user to login into the system to retrieve the messages (379).

Everyone who has joined the system can view their personal information on his or her Profile page. It's a centralized location where other users can see the user's public invention listing, link to favorite inventions, bulletins, comments, subscribers and invention log. Users can also see stats about the member, like how long he or she has been a member, the number of inventions the member has filed, how many issued patents, among others. The Profile is also an easy place for people to connect with the member, to send the member a message, share a channel, add as a friend, or add comments to the Profile. The system lets the user notify friends when the user posts a new invention. The user can share the invention or your entire list. The user can have friends subscribe to his or her profile, or the user can post the invention to a blog.

In one embodiment, friends are invited to join the system as follows: log in, go to the Account page and click the “Invite More Friends” button under “Friends & Contacts.” Invite one friend, or a bunch, by adding commas between their email addresses. Then add whatever personal message you'd like. Click “Send Invite,” and then wait for them to join up and start sharing inventive ideas with the member. Friends and any other user created lists allow the user to quickly share ideas with a large group of people. Once the user adds an individual to the contact list, the user can move the contact to the Friends list or any other lists. Then, the user can easily send interesting inventions to everyone on that list by clicking the “Share Invention” link, checking the box next to the appropriate list, and clicking the “Send” button. The user can also set privacy settings for his contact lists, which allows the user to make inventions visible only to members of that list. This makes it easy to share confidential information only with selected members.

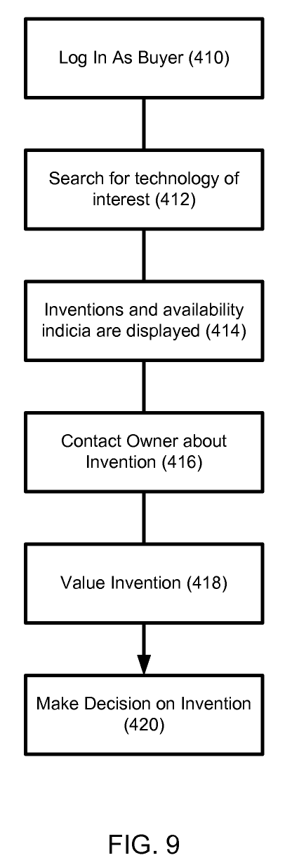

FIG. 9 shows an exemplary process from a buyer perspective. First, the buyer logs in to the system (410). Next, the buyer search for a particular IP, or alternatively the system automatically updates a search based on the user profile and presents an updated search screen showing available IPs (412). The system displays the inventions as well as their availability indicia (414). For example, the system can display that a sale is pending, or alternatively can indicate how many discussions have occurred for the IP. This information helps the buyer assess his or her position. Next, after reviewing the asset, the buyer can contact the owner and asks questions if needed (416). The buyer can also value or appraise the invention (418). In one embodiment of the appraisal, the system can provide the buyer of properties that have similar topics/tags and their selling prices. By viewing the appraisal as well as comments generated by other users on the invention, the buyer can make a decision (420).

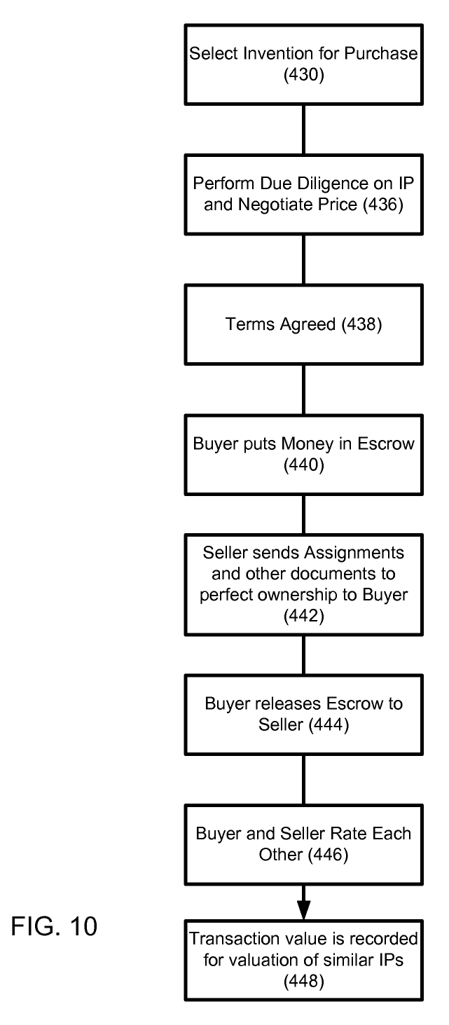

FIG. 10 shows an exemplary purchasing process. First, the user selects an invention for purchase (430). Next, due diligence is performed and price is negotiated (436). The terms are eventually agreed upon (438), and the buyer puts a portion of purchase money in escrow (440). The system receives the escrow money and notifies the seller to execute ownership transfer agreements, and the seller sends these documents including assignments and other documents to perfect ownership to the buyer (442). Upon receipt, the buyer tells the system to release escrow to the seller (444). Upon completion, the buyer and seller can rate and provide comment on each other (446). The system then records the value of the transaction as a basis for future appraisals of similar inventions (448).

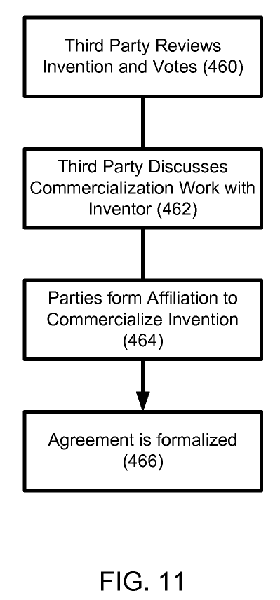

FIG. 11 shows an exemplary process where a third party can work with the inventor to productize the invention. First, the third party reviews the invention, votes and comments (460). Next, the third party discusses his/her ability to help the inventor to commercialize the invention (462). For example, if the third party is an investor, the third party can offer financing or help raise funding. If the third party is an IP specialist, the third party can help the inventor to prosecute the case. If the third party is an engineer, the third party can help design and manufacture the invention. If the third party is a distributor or a company with strategic interest in the field, the third party can form an alliance with the inventor to commercialize the invention. Other functions/assistance can be provided. The party can use the messaging system to discuss, negotiate, and finalize the relationship to commercialize the invention (464) and an agreement is formalized (466). Upon formalizing the relationship, the system can be used to bring additional partners or stakeholders that are needed to bring the idea to the market.

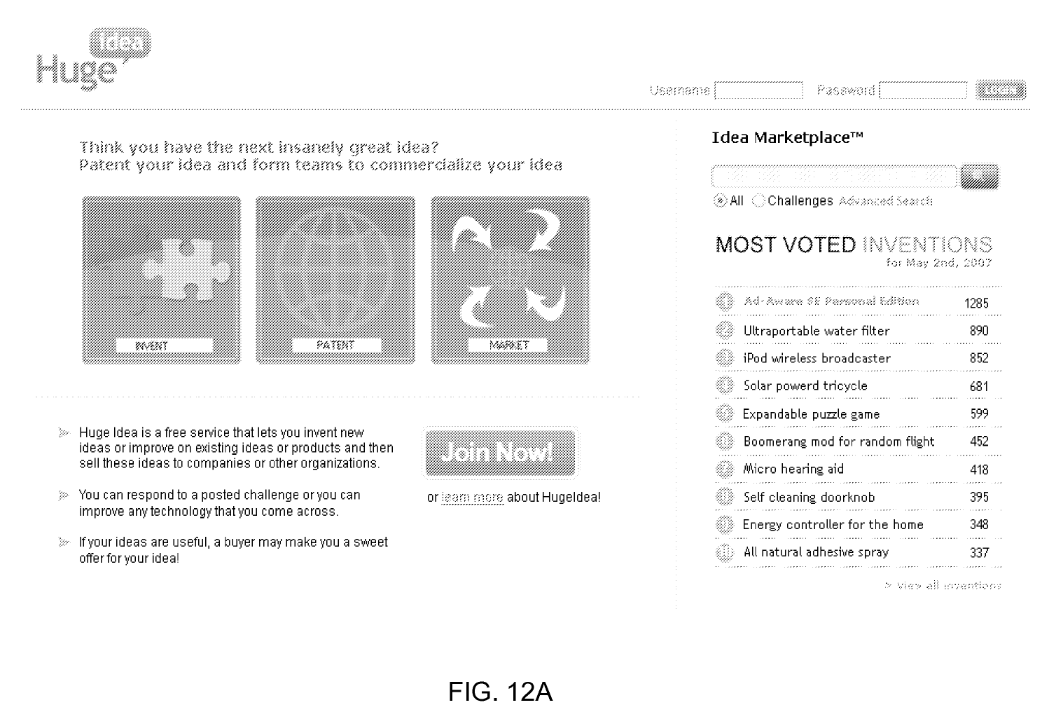

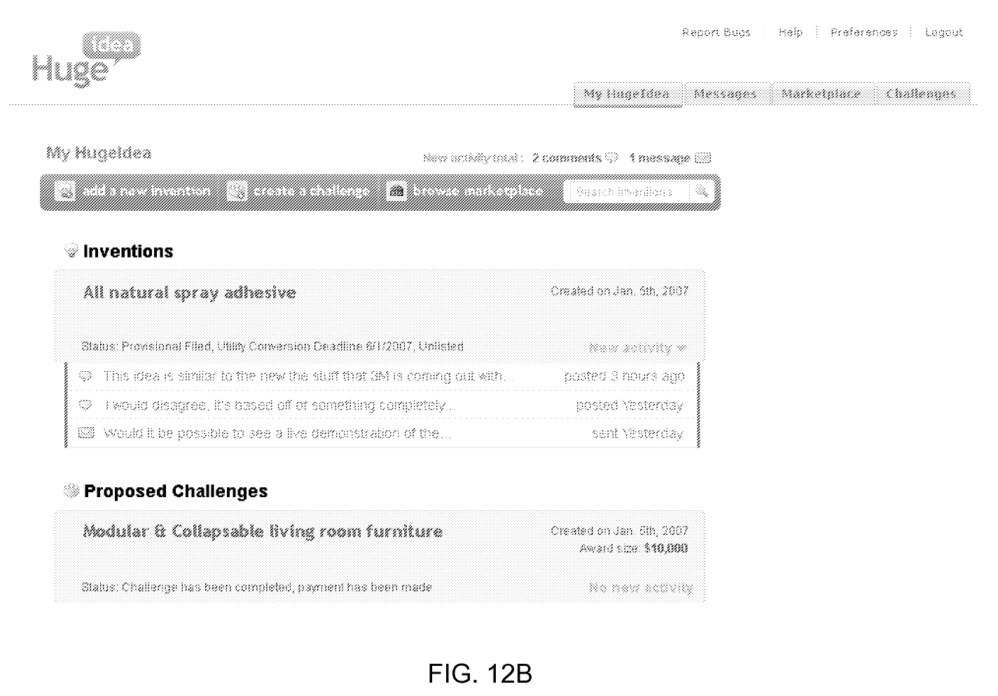

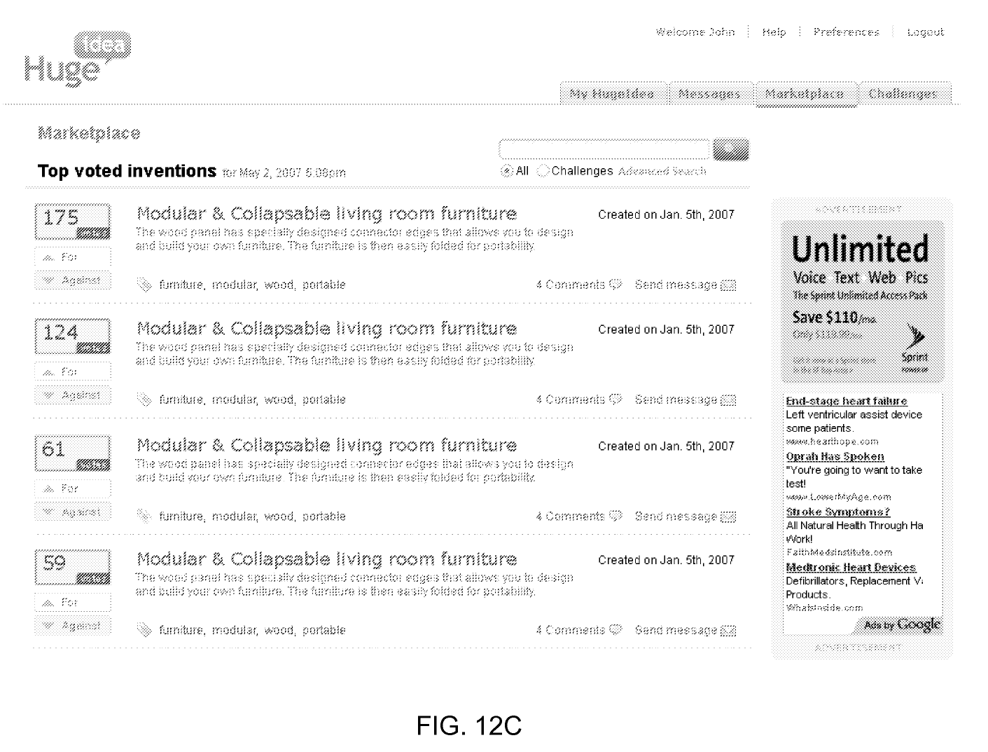

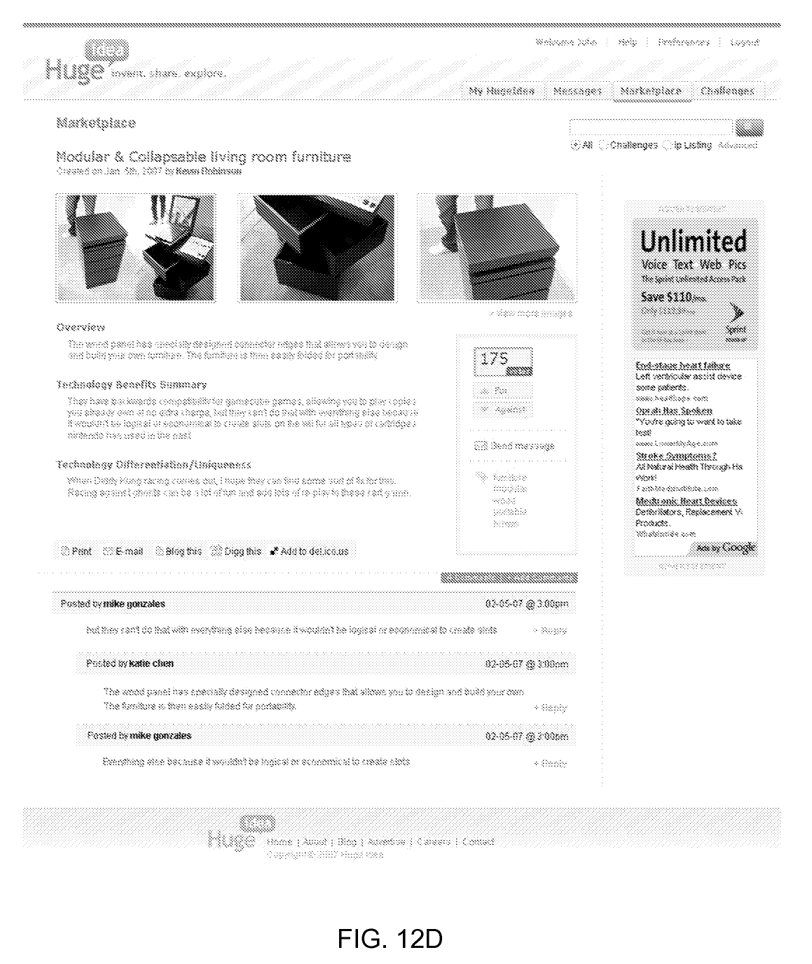

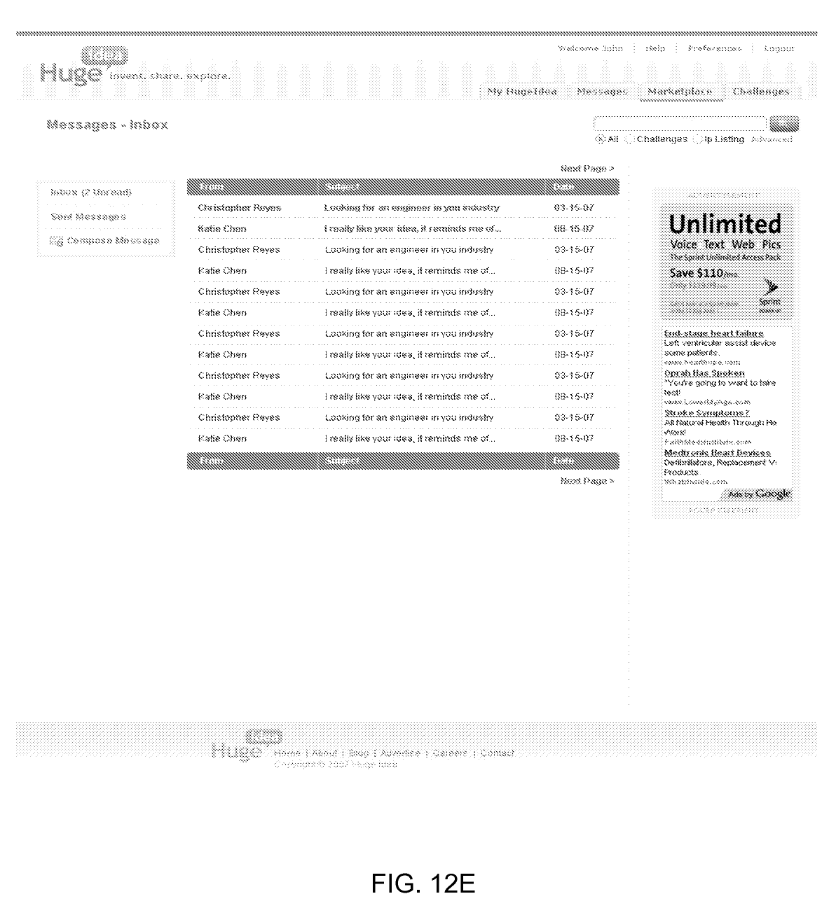

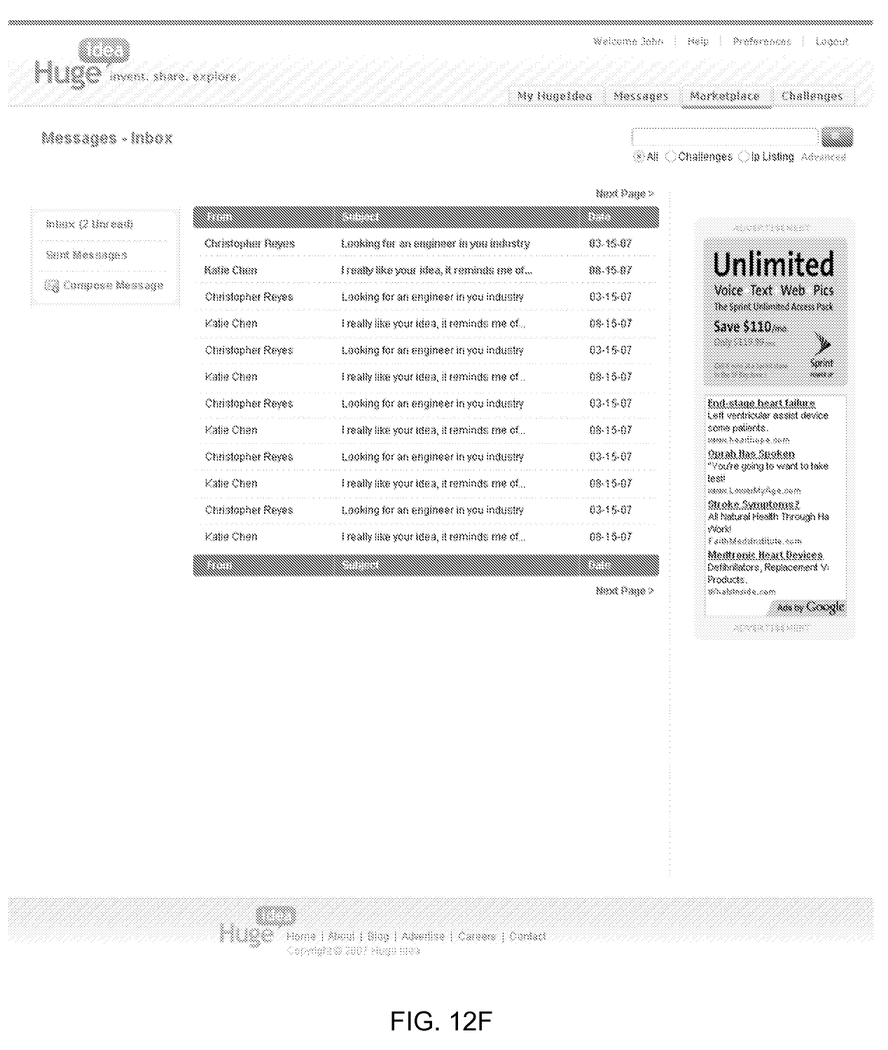

FIG. 12 shows various exemplary user interfaces for one embodiment of the system available at www.hugeidea.com.

In yet another aspect, the system provides data that can be used by other Semantic Web (Web 3.0) sites as well as consume data from the system's own database or from other Semantic Web sites in flushing out details of an invention.

In the IP Semantic Web system, IP related data on the web is defined and linked in a way that it can be used by machines not just for display purposes, but for automation, integration and reuse of data across various applications. The system can browse the Web and find what IP users are looking for based on what the system knows about the user's needs and the descriptive metadata they find on relevant sites. Data is connected to URLs containing descriptive information about that data. Information is neither static nor absolute; instead data is “an abstract concept” that gets definitions from another site explaining how to define the data.

To illustrate, in one example, the inventor invents a flying car by specifying a vehicle with at least two wheels, a frame coupled to the wheels, and an engine coupled to the frame to propel the vehicle through the air and the ground. Once the inventor has specified the claim(s), the system looks up prior art relating to vehicle frames, wheels, and engines and known equivalents thereof and automatically checks the prior art to see if it fits with the scope of the invention as defined by the inventor and to see if conflicts exist.

The Semantic Web system captures the true essence of meaning of each processed data object. The information allows the system to efficiently find the precise answer to queries, generate dynamic taxonomies of results, create on-the-fly summaries of located documents, and understand deep concepts such as cause-effect relationships. The system automatically provides simultaneous cross-language semantic search across multiple languages such as English, French, German and Japanese, among others. The objects being located are automatically transformed into their equivalent semantic concepts for the target languages allowing a single search to be processed against a variety of heterogeneous language knowledge bases.

In one example where the system automatically locates suitable propulsion device for the vehicle, the system treats “engine” as an abstract concept with definition from another invention or prior art explaining how to better define what engines can be used to make a flying vehicle. The system searches for non-patent documents that are tagged as relating to engines as well as patents that reference engine in the claims. Suitable candidates are brought back for the inventor to review. Upon inventor approval, the system automatically retrieves description associated with the object and customizes the object to fit with its environment as specified by the inventor.

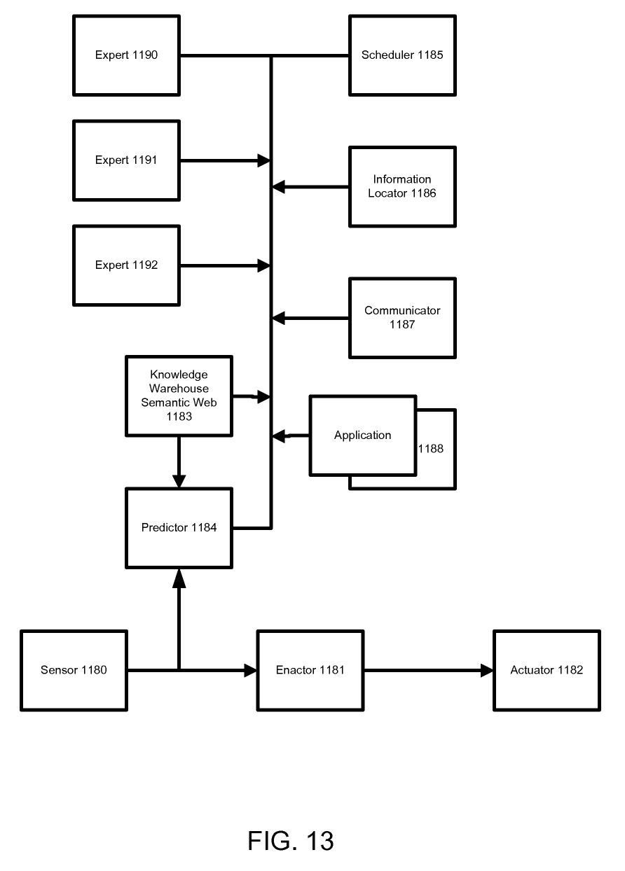

Turning now to FIG. 13, an intelligent agent that works with the Semantic Web is illustrated in more detail. In FIG. 13, one or more sensors 1180 receives incoming information. The sensors 1180 in turn transfer the data to an enactor 1181. The enactor 181 in turn makes a decision based on its current situational data, as captured by sensors 1180. The enactor 1181 then drives an actuator 1182. In addition to receiving data from the sensor 1180, the enactor 181 also receives instruction from a predictor/goal generator 1184, which in turn is connected to a general knowledge warehouse 1183. The external data sensed by the sensor 1180 is also delivered to both the warehouse 1183 and the predictor/goal generator 1184. Additionally, both the warehouse 1183 and the predictor/goal generator 1184 are connected to a plurality of specialist knowledge modules, including a scheduler 1185, an information locator 1186, a communicator 1187, a form filler 1188, a trainer 1189, a first expert 190, a second expert 191 and additional experts 192 for each technology that the inventor specializes in.

In one embodiment, the agent works with a Resource Description Framework (RDF), a general-purpose language for representing information in the Web. An XML syntax for RDF called RDF/XML in terms of Namespaces in XML, the XML Information Set and XML Base can be used. The formal grammar for the syntax is annotated with actions generating triples of the RDF graph as defined in RDF Concepts and Abstract Syntax. The triples are written using the N-Triples RDF graph serializing format which enables more precise recording of the mapping in a machine processable form. RDF is a language for representing information about resources in the World Wide Web. It is particularly intended for representing metadata about Web resources, such as the title, author, and modification date of a Web page, copyright and licensing information about a Web document, or the availability schedule for some shared resource. However, by generalizing the concept of a “Web resource”, RDF can also be used to represent information about things that can be identified on the Web, even when they cannot be directly retrieved on the Web. Examples include information about items available from on-line shopping facilities (e.g., information about specifications, prices, and availability), or the description of a Web user's preferences for information delivery.

RDF is intended for situations in which this information needs to be processed by applications, rather than being only displayed to people. RDF provides a common framework for expressing this information so it can be exchanged between applications without loss of meaning. Since it is a common framework, application designers can leverage the availability of common RDF parsers and processing tools. The ability to exchange information between different applications means that the information may be made available to applications other than those for which it was originally created. RDF is based on the idea of identifying things using Web identifiers (called Uniform Resource Identifiers, or URIs), and describing resources in terms of simple properties and property values. This enables RDF to represent simple statements about resources as a graph of nodes and arcs representing the resources, and their properties and values.

The agent can also work with the Web Ontology Language OWL, a semantic markup language for publishing and sharing ontologies on the World Wide Web. OWL is developed as a vocabulary extension of RDF (the Resource Description Framework) and is derived from the DAML+OIL Web Ontology Language. This document contains a structured informal description of the full set of OWL language constructs and is meant to serve as a reference for OWL users who want to construct OWL ontologies.

The knowledge warehouse 1183 has a representation for the user's world, including the environment, the kind of relations the user has, his interests, his past history with respect to the retrieved documents, among others. Additionally, the knowledge warehouse 1183 stores data relating to the external world in a direct or indirect manner to enable to obtain what the assistant needs or who can help the electronic assistant. Further, the knowledge warehouse 1183 is aware of available specialist knowledge modules and their capabilities since it coordinates a number of specialist modules and knows what tasks they can accomplish, what resources they need and their availability.

The scheduler 1185 ensures that requested events do not overlap in the event that a user appointment is being requested and that search events with approaching deadlines are provided appropriate resources and prioritization to accomplish the objective of the search. The information locator 1186 has knowledge of the user's preferences, as well as outstanding requests for information on certain topics. It periodically scans appropriate databases, and delivers summaries on a scheduled or on-request basis. The communicator 1187 interacts with electronic mails or requests for information. It knows the user's preferences and optimizes the presentation of e-mails in accordance with the user's prioritization pattern. Further, in the event of requests for information, in the event that the requester has appropriate authorization, the electronic assistant of FIG. 13 provides the information after consulting with the user about the appropriateness of such action. The form filer 1188 knows the user's data entry pattern and fills in the form with predicted information to minimize data entry on the part of the user for repetitive forms. The expert module 1190 provides a specific technology expertise (for example nanotechnology expertise) for the user, while the second expert 1191 monitors another technology of interest to the user. Additional experts 1192 provide specialist knowledge for specific fields of interest. The trainer 1189 provides custom training to the electronic assistant so that it can handle additional tasks not already supported by the modules 1185-1188 and 1190-1192. Additionally, although not shown, the present invention contemplates that a refresher module may be present to provide the user with additional views which may or may not be pressing for the moment. The refresher module provides unplanned interruptions and information received during the day to provide the user with additional perspectives. For example, the refresher module includes in the batch of information delivered to the user a quantity of non-requested information which might help the user arrive at solutions to other problems in addition to those scheduled by the scheduler. The operation of each of these modules is detailed below.

Upon powering up or log-on from step 1200, the routine proceeds to step 1201 where it retrieves a previously stored user profile. Next, the routine displays one or more application icons in step 1202. From step 1202, the routine activates the assistant of FIG. 13 in step 1203. Next, the routine waits if one of the applications on the user's computer is running. If not, the routine simply puts itself to sleep in step 1205 so that other background processes can be executed more efficiently. From step 1205, the routine periodically wakes up and checks for the activation of an application that it needs to handle.

In the event of the activation of an application in step 204, the routine proceeds to step 1206 where it retrieves the environmental data such as the type of application being executed, the time of execution, other outstanding applications and data coming from the sensor 1180. Once the environment has been assessed in step 1206, the routine executes the selected application in step 1207 and also opens an assistant interface dialog in step 1208. The assistant in step 1208 displays information which may help the user in remembering prior events that are associated with the application.

Once the application completes its operation in step 1207, the routine proceeds to step 1209 where it checks if the user is logging-off or if a shutdown is about to occur. If not, the routine loops back to step 1204 where it awaits the next application to be launched. Alternatively, in the event of a log-off or power down, the routine exits.

Next the process of capturing a user profile is shown. The user can provide his or her profile to the assistant during his or her first session. Upon entering in step 1220, the routine proceeds to step 1221 where it checks for a new user. If so, the routine proceeds from step 1221 to step 1222 where it requests the user to enter his or her profile and preferences. The user can set different profiles each reflecting an interest area. Among the different preferences, the user can select the types of semantic sites, sites with tagged contents, or archives he is interested in, e.g., ftp, gopher, wais, among others. He can also set a personal list containing the sites in which documents of user's interest are found more frequently or other similar interests have converged on as evident from the de.licio.us's tagging or the stumbleupon.com's tagged sites. From step 1222, the routine then initializes a profile table in step 1223.

In the event that the user is an existing user in step 1221, the routine proceeds to step 1224 where it consolidates and updates the user profile table. Next, from step 1223 or 1224, the routine proceeds to step 1225 where it enables a background capture of user characteristics via a profiler. The profiler transparently captures the user activities, and based on the actions taken as well as the time taken to perform the action, allows the electronic assistant of FIG. 13 to predict next user actions based on past observations and hypothesis. Once the background capture has been started, the routine exits. In this manner, the assistant keeps tracks of the evolution of the user's interests by maintaining a dynamic profile that takes the user's behavior into account. The specificity of the profile increases with the user's awareness about the available information and how to get it. The possibility of a relevance feedback is particularly important in the context of the final system. Using the user's profile, the assistant can in turn launch specialized agents to navigate through the network hunting for information of interest for the user. In this way, the user can be alerted when new data that can concern his interest areas appear.

A flowchart illustrating the operation of the form filler is discussed next. The form filler 1188 provides automatic form filling capability to simplify the user's completion of repetitive forms. The form filler 1188 examines initial data entries in data fields of the present form, and if a matching pattern exists, the form filler 1188 generates predicted field values and enters the proposed values into the form for the user to approve. Alternatively, in the event that no matching pattern is available, the form filler 1188 enters a learning mode where it captures the relationship of the newly entered data for future applications. In one embodiment, the form filler completes the description in the patent application for elements recited in the claims that are known by searching up the patent and other databases. In this manner, the form filler can be an automated apprentice to complete the master design crafted by the inventor. Upon entering the form filler in step 1530, the routine proceeds to step 1531 where it displays the requested form. Next, the routine proceeds to step 532 where it receives initial data inputs from the user. After a few entries have been entered, the routine searches in its memory bank for previous entries with similar data inputs in step 1533. Next, in step 1534, the routine checks if an entered form with initial entries matching the data entered in step 1532. If a matching set of entries exist, the routine proceeds from step 1534 to step 1535 where it copies the content of the form with matching initial entries into the current form. If not, the routine proceeds to step 1537 where it captures the rest of the data entry for the form. From step 1535, the routine proceeds to step 1536 where the routine awaits user approval. If the user disapproves in step 1536, the routine clears the copied data before moving to step 1537 to allow the user to enter new data. Alternatively, in the event that the user approves in step 1536, the routine proceeds to step 1538 where it saves the automatically filled in data for the user. From step 1537 or 1538, the routine updates the history statistics with the newly saved data to improve its next prediction before the routine exits. Preferably, the learning system uses an ID4 decision tree process, as known in the art. Further, the system can predict strings within a field. The string predictor predicts the complete string based on a partial entry of that string by the user and based on examples the system has already seen in that field.

The operation of the trainer is discussed next. From step 1290, the routine proceeds to step 1291 where it checks if the user wishes to manually train the intelligent assistant by providing explicit sequences to the assistant, similar to that of a macro training operation. From step 1291, in the event that the user wishes to manually train the assistant, the routine proceeds to step 1292 where it prompts the user for a particular task to train the assistant on. From step 1292, the routine proceeds to step 1293 where it captures user strokes and task activities associated with the strokes. Alternatively, in the event that the assistant is to learn its task through inference, the routine proceeds from step 1291 to step 1294 where it captures the user strokes and application activities over a predetermined period. Next, the strokes and activities are analyzed for patterns in step 1295. If a pattern is established in step 1296, the routine proceeds to step 1297 where it groups the data by clusterizing the captured user strokes and application patterns. From step 1297, the routine proceeds to step 1298 where it partitions the clusters into new categories. Next, in step 1299, the routine fuses the new categories with existing categories.

From step 1293 or step 1299, the routine trains the assistant in step 1300. After training, the newly trained module is added to the intelligent assistant functionality in step 1301. From step 1301, or from step 1296, the routine exits.

Turning now to the process for operating the information locator, the routine proceeds to step 310 where it requests a search budget from the user. The budget may be monetary or may be time spent performing the search or the number of sites or tags to search. Next, the routine request that the user identify the search domain in step 1311. The suggested search domain, based on prior user history and preference, may be displayed on the screen for the user to approve. From step 1311, the routine requests that the user prioritize the search request relative to outstanding requests. The suggested prioritization of the search, based on prior user history and preference, may be displayed on the screen for the user to approve. In step 1313, the deadline and search intervals are identified.

From step 1313, the electronic assistant of the present invention generates a search query in step 1314 based on a general discussion of the search topic by the user. The assistant then refines the search query in steps 1315-1316 where it expands the search query using a thesaurus to add related terms and concepts. Further, the assistant searches the computer's local disk space for related terms and concepts, as terms and concepts in the user's personal work space is relevant to the search request. In this manner, based on its knowledge of the user's particular styles, techniques, preferences or interests, the information locator can tailor the query to maximize the search net. Next, the routine proceeds to step 1317 where it adds the query to the search launchpad database which tracks all outstanding search requests. From step 1317, the information locator broadcasts the query to one or more information sources and awaits for search results. Upon receipt of the search results, the information locator communicates the results to the user, and updates the knowledge warehouse 1183 with responses from the user to the results.

In this manner, the information locator presents a list of keywords in the search which identifies a possible set of documents for which the user can choose a particular action. Then he can specify the number of items he wants and if there is a time in which he prefers to activate the search. The retrieved documents are shown to the user according to the preference values in the current profile. The assistant tracks the user's behavior concerning the documents retrieved in both surfing and query modes. After each search cycle in the surfing mode, the retrieved documents are proposed to the user who can decide to refuse or accept each of them. The rejected documents are stored in a database and successively compared with the sets of incoming documents in order to refine the boundaries of the search. Thus, if items in the incoming set are found similar to some of the rejected documents, the assistant discards the former. As a consequence the documents proposed to the user are closer to his actual interests. In the query mode, the user's requests are also used to refine the profile. The rejected documents are added to the database, while for each query a profile is extracted from the set of accepted items that the assistant adds to the profiles database.

Although the electronic assistant can reside on a single computer, the information locator can be located in either the host computer or on the handheld computer. When the assistant operates in an environment equipped with a handheld computer which is adapted to work with a host computer, the assistant splits into two personalities, one residing on the handheld computer with the intelligent desktop assistant for interacting with the user and one residing on a host computer with the information locator for executing searches in the background. When results are found, the assistant running on the host computer prioritizes the retrieved documents. Further, the assistant on the host computer transforms the data designed to be sent to the handheld computer into an equivalent file optimized for fast and robust wireless transmission. The assistant then immediately transmits the transformed, high priority documents to the handheld computer through a wireless modem while withholding lower priority documents for transfer when the handheld computer docks with the host computer to minimize data transmission costs. Further, upon docking, the assistant on the handheld computer synchronizes its knowledge base with the assistant running on the host computer to ensure that the personalities on the handheld and host computers have consistent knowledge of their environments.

The process for carrying out the search is shown in more detail next. From step 1320, the routine proceeds to step 1321 where it checks if the allocated budget is depleted. If so, the routine moves to step 1322 where it requests more resources to be allocated to the search process. Next, in step 1323, the routine checks if the user has increased the budget or not. If not, the routine kills the search requests and exits as it is out of resources. In this manner, the economic based competitive allocation system ensures that only worthwhile searches are performed.

In the event that the budget has not been exceeded in step 1321, the routine checks in step 1325 if the previous search results are good enough that no additional search needs to be made, even if the deadline and remaining budget permits such search. If so, the routine simply exits. Alternatively, in the event that the remaining budget is sufficient to cover another search, the routine moves to step 1324 where it checks on the closeness of the deadline. If the deadline is very near, such as within a day or hours of the target, the routine elevates the priority of the current search in step 1326 to ensure that the search is carried out in a timely fashion. From step 1324 or 1326, the routine checks in step 1327 if it is time for an interval search, which is intermediate searches conducted periodically in satisfaction of an outstanding search request. If so, the routine proceeds from step 1327 to step 1328 where it sends the query to the target search engine(s).

The search tracks the intercepted URLs involving the formation of new searches cause the spawning of new search processes that will execute either through a single completion of a multiple engine search or through an indefinite number of search completions, each occurring at an interval specified by the user at the time of the initial request. Searches can be scheduled through the search engines currently available on the web such as a Semantic Web search engine such as SearchMe or engines such as Google, Yahoo, MSN, Lycos, Web Crawler, Spider etc., at a constant interval set by the user. The assistant optionally reports to its user if a specific search is fulfilled or in progress through the inclusion of a footer to pages currently displayed on the user's browser.

Once the query has been submitted, the electronic assistant periodically checks the status of the search. In step 1329, in the event that the search engine has failed for some reason, the routine reroutes the search to reach a mirror search engine in step 1330 if available, or substitute a less preferred, but operational search engine. From step 1329 or 1330, in the event that new information has been located, the routine informs the user in step 1332 such that the user is notified if a specific search has new search result since last database retrieval. Otherwise, the routine proceeds to step 1333 where it sleeps to await the next interval search.

In this manner, the assistant automatically schedules and executes multiple information retrieval tasks in accordance with the user priorities, deadlines and preferences using the scheduler. The scheduler analyzes durations, deadlines, and delays within its plan in while scheduling the information retrieval tasks. The schedule is dynamically generated by incrementally building plans at multiple levels of abstraction to reach a goal. The plans are continually updated by information received from the assistant's sensors, allowing the scheduler to adjust its plan to unplanned events. When the time is ripe to perform a particular search, the assistant spawns a child process which sends a query to one or more remote database engines. Upon the receipt of search results from remote engines, the information is processed and saved in the database. The incoming information is checked against the results of prior searches. If new information is found, the assistant sends a message to the user.

While the result of the search is displayed to the user, his or her interaction with the search result is monitored in order to sense the relevancy of the document or the user interest in such search. Turning now to the routine to monitor the user interest, from step 1340, the routine displays the next result or document found by the information locator. Next, in step 1342, a timer is initialized to track the time taken to review the document displayed in step 1341. In the event that the document is an HTML page with links, the routine detects whether the user has selected one of the links in step 1343. If not, the routine calls a HyperText link (hyperlink) handler in step 1344. From step 1344, or from step 1343 if the user has not selected the Hyperlink, the routine proceeds to step 1345 where it checks if the user has reviewed all relevant documents found during the search. If not, the routine loops back to step 1341. Alternatively, in the event that the user has reviewed every document found during the instant search, the routine computes in step 1346 the time the user spent on the entire review process, as well as the time spent on each document. Documents with greater user interest, as measured by the time spent in the document as well as the number of hypertext links from each document, are analyzed for new keywords and concepts in step 1347. Next, the new keywords and concepts are clusterized using cluster procedures such as the k-means clustering procedure known in the art and the resulting new concepts are extracted in step 1348. Next, in step 1349, the query stored in the database is updated to cover the new concepts and keywords of interest to the user. In this manner, the procedure adapts to the user interests and preferences on the fly so that the next interval search is more refined and focused than the previous interval search.

Referring now to the procedure to handle the hyperlinks, the procedure is recursive in nature such that when the user is in a document, the user can invoke further instances of the process to examine other hyperlink documents in succeeding reviews. From step 1350, the routine stores the hyperlink title in the list of keywords to be clusterized, as the hyperlink title had some causal relationship to the user's decision to examine the particular hypertext link. From step 1351, the routine jumps to the document pointed to by the hyperlink in step 1351. Once the new document is displayed, the routine checks in step 1353 whether the user has clicked the hyperlinks within the new document. If so, the routine recursively calls itself in step 1354. Alternatively, the routine proceeds from step 1353 to step 1355 where it checks if the user has decided to go back to the parent hyperlink. If not, the routine loops back to step 1353 to allow the user to continue viewing the document. Alternatively, the routine proceeds from step 1355 to step 1356 where the keywords in the title as well as highlighted terms of interest are added to the new keyword list for subsequent cluster analysis. From step 1356, the routine exits.

Referring now to the routine to determine the deadline associated with a particular search request, the routine moves to step 1361 where it correlates the terms of the search and the ToDo list items. In step 1362, in the event of a high correlation between the search request and the ToDo item, the routine proceeds to step 1363 where it highlights the ToDo list item and links the item to the search word. Next, in step 1364, the routine checks for user approval of the determined relationship. If the user accepts, the routine proceeds from step 1364 to step 1365 where it extracts the deadline associated with the ToDo list item and tags the search request with the same deadline. From step 1365, or in the event that the test in step 1362 or 364 is negative, the routine moves to step 1366 where it further checks if the user has specified particular deadlines. If not, the routine loops back to step 1361 to continue the deadline determination process. Alternatively, in the event that the user has defined a deadline, the date and time selected by the user overrides the system determined deadline. Thus, in step 1367, the entered date and time deadline is applied as the deadline for the search. Next, in step 1368, the search scheduler proceeds through an optimization process to maximize the search broadcast frequency while minimizing cost. A number of numerical optimization processes may be used. Additionally, simulated annealing may be used to optimize the search schedule. Once optimized, the search database is updated with the new schedule in step 368.

The process for detecting the context is illustrated in more detail. The routine proceeds to step 1381 where it senses its present location in the Semantic Web. The location of the assistant in cyberspace is specified in terms of the application, a conventional directory address or a hyperlink address. Additionally, step 1381 detects the current cyberspace environment where the assistant is operating from. Next, in step 1382, the routine reviews the history of searches previously performed at the cyberspace location. The historical analysis is then used to enhance the search query. In step 1383, the routine executes the search in accordance with the revised keywords. Next, in step 1384, the routine checks for potential association between the documents located by the search and the cyberspace context where the assistant is located. If a relationship exists, the routine moves from step 1384 to step 1385 where it captures user interest in the displayed search results by tracking time spent on each document as well as hypertext links selected within each document. Next, in step 1386, the routine extracts and adds the new keywords and concepts into the new keyword list for subsequent analysis before the routine exits.

The system searches for information relating to the competition as well as other potential stakeholders. The search starts with in-house data and sweeps outwardly toward the Internet using the intelligent assistant of FIG. 13. As a first step, the agent enters the respective competitor's name into search engines such as Google, MSN, Yahoo, AltaVista, HotBot or Infoseek. The agent may also check the competitor's financial health by performing a search in Hoover's Online, located at http://www.hoovers.com, and a search at the U.S. Securities & Exchange Commission, located at http://www.sec.gov. Other sites with financial information on public and private companies that can be searched by the agent include http://www.pathfinder.com, http://www.avetech.com, http://www.dbisna.com.

For general news regarding a particular company, the agent can search Ecola's 24-hour newsstand, located at http://www.ecola.com, which links to more than 2,000 newspapers, journals, magazines and publications. Additionally, the agent can search CNN Interactive at http://www.cnn.com for archived information going back a few weeks. Furthermore, the agent can search the Knowledge Index on CompuServer, and the Electric Library, available at http://www.elibrary.com, for scouring magazines, reference works and news wires. Furthermore, MediaFinder, located at http://www.mediafinder.com, provides an index and description of thousands of newsletters, catalogs and magazines. The agent also provides the ability to listen in on conversations regarding a particular company by news groups and discussion groups prevalent in the Usenet section of the Internet. For a searchable directory of E-mail discussion groups, the agent reviews Deja News Research Service, located at http://www.dejanews.com, and Liszt, located at http://www.liszt.com.

As a last resort when the above searches turn up empty, the agent at step 1584 checks sites that have compiled good collections of business resources, including John Makulowich's Awesome Lists, located at http://www.clark.net, American Demographics, located at http://www.demographics.com, ProfNet, located at http://www.vyne.com, StartingPoint, located at http://www.stpt.com, Babson College, located at http://babson.edu, and Competitive Intelligence Guide, located at http://www.fuld.com. Additionally, the present invention contemplates that yet other sites can be searched as well for competitive information, including the Lexis/Nexis database, the Westlaw database, various judicial decisions at Villanova University, licensing information from Licensing Executive Society at http://www.les.org, and the patent abstract information database from the U.S. Patent & Trademark Office, or alternatively, abstracts from MicroPatent, located at http://www.micropat.com, among other sites.

The assistant of the present invention thus transparently assists the user in performing requests and compiling his profile. The user does not need to be aware of what is available on the network; how this information is structured and organized; where the repositories are localized; what retrieval services are at disposal. The assistant deduces the user's information needs by both communicating with the user and observing his or her behavior to deduce what actions are to be performed and how to modify the current user's profile. The user may or may not be aware of the learning or training of the electronic assistant, depending on both the user features and the processing step. The interface assistant translates the requests of the user and selecting other experts or agents who can solve the user's problems. In this manner, the user interacts with a personalized interface to allow him to completely ignore the structure of the system he is interacting with or how the system works. Further, the assistant of the present invention acquires and retains an interest profile of its user and acts upon one or more goals based upon that profile. The assistant further acts autonomously, pursuing the goals posed to it by its user, irrespective of whether the user is connected to the system where the assistant is based. The assistant also apprises its user of progress towards outstanding goals, and present preliminary results during the acquisition of information in the satisfaction of a goal.

The agent understands ontology. An ontology defines the terms used to describe and represent an area of knowledge. Ontologies are used by people, databases, and applications that need to share domain information (a domain is just a specific subject area or area of knowledge, like medicine, tool manufacturing, real estate, automobile repair, financial management, etc.). Ontologies include computer-usable definitions of basic concepts in the domain and the relationships among them (note that here and throughout this document, definition is not used in the technical sense understood by logicians). They encode knowledge in a domain and also knowledge that spans domains. In this way, they make that knowledge reusable.

The agent operates with the Semantic Web ontologies with a significant degree of structure. These need to specify descriptions for the following kinds of concepts:
Classes (general things) in the many domains of interest
The relationships that can exist among things
The properties (or attributes) those things may have

The agent interprets ontologies xpressed in a logic-based language, so that detailed, accurate, consistent, sound, and meaningful distinctions can be made among the classes, properties, and relations. Some ontology tools can perform automated reasoning using the ontologies, and thus provide advanced services to intelligent applications such as: conceptual/semantic search and retrieval, software agents, decision support, speech and natural language understanding, knowledge management, intelligent databases, and electronic commerce. Ontologies are used for representing the semantics of documents and enabling the semantics to be used by web applications and intelligent agents. Ontologies can prove very useful for a community as a way of structuring and defining the meaning of the metadata terms that are currently being collected and standardized. Using ontologies, tomorrow's applications can be “intelligent,” in the sense that they can more accurately work at the human conceptual level.

Ontologies enable agents to search across or merge information from diverse communities. Although XML DTDs and XML Schemas are sufficient for exchanging data between parties who have agreed to definitions beforehand, their lack of semantics prevent machines from reliably performing this task given new XML vocabularies. The same term may be used with (sometimes subtle) different meaning in different contexts, and different terms may be used for items that have the same meaning. RDF and RDF Schema begin to approach this problem by allowing simple semantics to be associated with identifiers. With RDF Schema, one can define classes that may have multiple subclasses and super classes, and can define properties, which may have sub properties, domains, and ranges. In this sense, RDF Schema is a simple ontology language. However, in order to achieve interoperation between numerous, autonomously developed and managed schemas, richer semantics are needed. For example, RDF Schema cannot specify that the Person and Car classes are disjoint, or that a string quartet has exactly four musicians as members.

In one embodiment, Ruby-On-Rails is used to implement the system. The web server receives a request from a browser. A request consists of a URL and optional parameters which may or may not be part of the URL. The web server is configured to serve static resources such as stylesheets and images. If the URL does not match a static resource, the web server sends it to the Rails application for handling. The exact mechanism for doing this depends on both the specific web server and interface protocol that the Rails application is using (CGI, FCGI, SCGI, and so on). The system parses the URL to determine the controller, action, and parameters for the request. With Rails routing, parts of the URL can specify additional parameters and the entire routing process is under the system's control. Routing rules work the same on any web server because Rails controls all URL processing with the code in configuration files without relying on the web server. The default routing is http://<base-url>/<controller>/<action>/<id>. The router calls the target action method in the target controller. The action method retrieves any needed data from any business logic in Active Record models, Action Web Services, or other backend APIs. The action method then assigns that incoming data to instance variables. The system automatically makes any instance variables created in the action method available to the views. The action method either lets the default view template render the response, specifies a view template to render, or redirects the response to another URL. Most commonly, the action renders the default view template, which has the same name as the action. The system renders a view template to create the HTML response text that is sent back to the browser. A view template may generate the entire HTML response, but more likely is that the controller will have specified a layout template that is rendered first, with the contents of the view template being inserted into the layout. Layouts make it easy to include headers, footers, and other content—that should appear on every page. The view template can also cause other small templates, called partials, to be rendered and inserted Into the view template's output. This approach is great for rendering elements than are used on more than one page or multiple times on a single page because the code won't have to be duplicated. After combining the rendered output of the layout, view template, and any partials invoked by the view template, the resulting HTML response text is sent back to the browser.

To improve speed, static pages are cached. Pages that are the same for all users or pages available to the public with no authentication needed are cached. A “caches-page” directive tells the application that next time a particular action is requested, take the resulting html, and store it in a cached file.

The system uses Ajax, shorthand for “Asynchronous JavaScript and XML.” Ajax makes web pages feel more responsive by exchanging small amounts of data with the server behind the scenes, so that the entire web page does not have to be reloaded each time the user requests a change. This is intended to increase the web page's interactivity, speed, and usability. The Rails system has a simple, consistent model for how it implements Ajax operations. Once the browser has rendered and displayed the initial web page, different user actions cause it to display a new web page (like any traditional web app) or trigger an Ajax operation:

1. A trigger action occurs. This could be the user clicking on a button or link, the user making changes to the data on a form or in a field, or just a periodic trigger (based on a timer).

2. Data associated with the trigger (a field or an entire form) is sent asynchronously to an action handler on the server via XMLHttpRequest.

3. The server-side action handler takes some action (that's why it is an action handler) based on the data, and returns an HTML fragment as its response.

4. The client-side JavaScript (created automatically by Rails) receives the HTML fragment and uses it to update a specified part of the current page's HTML, often the content of a <div> tag.

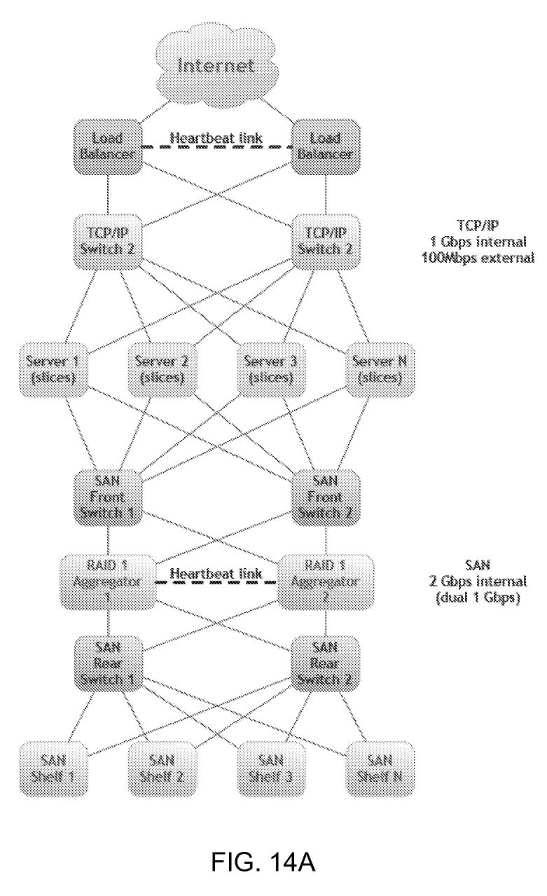

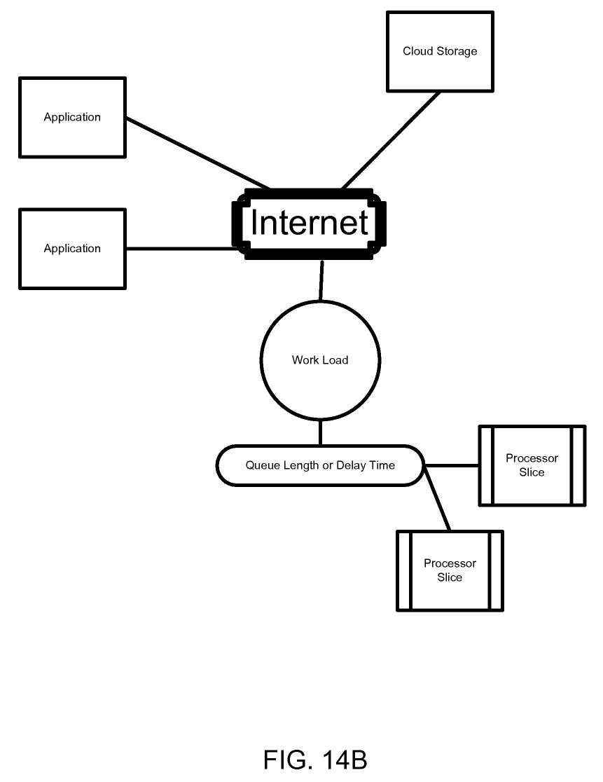

To provide high performance, a clustered, load balanced server system is used. As shown in FIG. 14A, load balancers are connected to the internet and TCP/IP switches are used to direct web request to different server slices. The servers are connected to storage area network (SAN) switches which are connected to RAID aggregators. The RAID aggregators in turn communicates with rear SAN switches which interfaces with a plurality of SANs.

In another embodiment shown in FIG. 14B, a grid computing service system such as Amazon.com's Elastic Compute Cloud (EC2) web computing system can be used. The grid computing system is a web service that provides resizable compute capacity in the cloud. It is designed to make web-scale computing easier for developers. The grid computing system differs fundamentally in the flexibility, control and significant cost savings it offers developers, allowing them to treat the grid computing system as their own personal data center with the benefit of a robust infrastructure. When computing requirements unexpectedly change (up or down), the grid computing system can instantly respond, meaning that developers have the ability to control how many resources are in use at any given point in time. In contrast, traditional hosting services generally provide a fixed number of resources for a fixed amount of time, meaning that users have a limited ability to easily respond when their usage is rapidly changing, unpredictable, or is known to experience large peaks at various intervals. With the grid computing system, developers enjoy the benefit of paying only for their actual resource consumption—and at very low rates. Most hosting services require users to pay a fixed, up-front fee irrespective of their actual computing power used, and so users risk overbuying resources to compensate for the inability to quickly scale up resources within a short time frame.

In one embodiment shown in FIG. 14B, one ore more applications consume computing power by making request through the Internet. Data can be stored in a cloud storage from one or more processor slices. A work load sensor provides utilization feedback in the form of queue length or delay time. If the queue length exceeds a predetermined size, or the delay time exceeds a threshold, then additional slices can be added or removed as appropriate. The grid computing system enables “compute” in the cloud. The grid computing system's simple web service interface allows a developer to obtain and configure capacity with minimal friction. The grid computing system reduces the time required to obtain and boot new server instances to minutes, allowing a developer to quickly scale capacity, both up and down, as the computing requirements change. The grid computing system changes the economics of computing by allowing the developer to pay only for capacity actually used.

Until now, small developers did not have the capital to acquire massive compute resources and insure they had the capacity they needed to handle unexpected spikes in load. The grid computing system such as Amazon's EC2 enables any developer to leverage Amazon's own benefits of massive scale with no up-front investment or performance compromises. Developers are now free to innovate knowing that no matter how successful their businesses become, it will be inexpensive and simple to ensure they have the compute capacity they need to meet their business requirements.

The “Elastic” nature of the service allows developers to instantly scale to meet spikes in traffic or demand. When computing requirements unexpectedly change (up or down), The grid computing system can instantly respond, meaning that developers have the ability to control how many resources are in use at any given point in time. In contrast, traditional hosting services generally provide a fixed number of resources for a fixed amount of time, meaning that users have a limited ability to easily respond when their usage is rapidly changing, unpredictable, or is known to experience large peaks at various intervals. The grid computing system enables the developer to increase or decrease capacity within minutes, not hours or days. The developer can commission one, hundreds or even thousands of server instances simultaneously. When more instances are needed, the system invokes EC2's RunInstances, and the grid computing system will typically set up new instances in a matter of minutes. Of course, because this is all controlled with web service APIs, an application can automatically scale itself up and down depending on its needs.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

What is claimed is:

1. A method to commercialize intellectual property (IP), comprising
a. posting on an IP social network publicly accessible information relating to an IP asset;
b. providing a messaging system linking members of the IP social network;
and
c. promoting the IP asset using the IP social network.

2. The method of claim 1 comprising performing one of: vote on the IP asset, rate the IP asset, tag the IP asset using folksonomy, blog on the IP asset, disseminate information on the IP asset using Really Simple Syndication (RSS), comment on the IP asset, discuss prior art, send a description of the IP asset to another person.

3. The method of claim 1, comprising submitting a listing to one of: digg.com, netscape.com, del.icio.us, flickr.com, slashdot.com, youtube.com.

4. The method of claim 1, comprising providing a reward for prior art relevant to the IP.

5. The method of claim 1, comprising soliciting help through the IP social network to crow-source one or more ideas or inventions addressing a predetermined problem.

6. The method of claim 1, comprising valuing the IP asset based on one of: a similar prior transaction, a cash flow analysis, a reasonable royalty analysis.

7. The method of claim 1, comprising providing escrow to facilitate IP asset transfer between two or more parties.

8. The method of claim 1, comprising selecting one or more contacts to create a private discussion group.

9. The method of claim 8, comprising determining a connection path from an existing contact to a predetermined person not a member of the private discussion group using social network analysis.

10. The method of claim 8, comprising requesting an introduction from an existing contact for one or more additional introductions to invite a predetermined person to join the private discussion group.

11. The method of claim 8, comprising paying for an introduction to invite a predetermined person to join the private discussion group.

12. The method of claim 1, comprising receiving an offer from one or more members of the IP social network, including: a business partner, an engineering professional, a sales professional, a marketing professional, a manufacturing professional, a compliance professional, a business professional.

13. The method of claim 1, comprising:
a. generating a patent application describing the IP asset;
b. providing a visual user interface including a tree-based visualization of parts of the patent application;
c. providing a drag-and-drop user interface to facilitate generating language recited in each claim of the patent application; and
d. providing diagnostics on the patent application.

14. The method of claim 1, comprising filing a patent application using an Electronic Filing System (EFS).

15. The method of claim 1, comprising filing a patent application using an application programming interface (API) to communicate the patent application and supporting data with a patent office.

16. The method of claim 1, comprising receiving a bid from one or more patent professionals reviewing the publicly accessible information to convert a provisional patent application to a utility patent application.

17. The method of claim 1, comprising providing an automated system to convert a provisional application into a utility patent application.

18. The method of claim 1, comprising providing a docketing system to calendar one or more deadlines and copying electronic files associated with the patent application from one or more patent offices and allowing a user to locally access the copied electronic files.

19. The method of claim 1, comprising providing an agent coupled to a Semantic Web to generate the IP asset or to commercialize the IP asset.

20. A method to commercialize intellectual property (IP), comprising
a. posting on an IP social network publicly accessible information relating to an IP asset;
b. selecting one or more contacts to create a private discussion group within the IP social network;
c. providing a messaging system linking members of the IP social network;
d. performing one of: vote on the IP asset, rate the IP asset, tag the IP asset using folksonomy, blog on the IP asset, disseminate information on the IP asset using Really Simple Syndication (RSS), comment on the IP asset, discuss prior art, send a description of the IP asset to another person; and
e. providing an on-line marketplace for the IP asset.
